(19) United States
(12) Patent Application Publication
(10) Pub. No.: US 2009/0016777 A1
(43) Pub. Date: Jan. 15, 2009

(54) DEVELOPER CONTAINER FILLED WITH DEVELOPER FOR IMAGE FORMING APPARATUS, AND METHOD FOR PRODUCING DEVELOPER CONTAINER FILLED WITH DEVELOPER

(76) Inventors: SATORU MIYAMOTO, Kanagawa (JP); KIYONORI TSUDA, Kanagawa (JP); EMI KITA, Tokyo (JP); MUGIJIROU UNO, Kanagawa (JP); KEIKO MATSUMOTO, Kanagawa (JP); MAIKO KOEDA, Shizouka (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/166,951

(22) Filed: Jul. 2, 2008

(30) Foreign Application Priority Data
Jul. 13, 2007 (JP) 2007-184269
Aug. 21, 2007 (JP) 2007-214479
Feb. 13, 2008 (JP) 2008-031283

(51) Int. Cl. G03G 15/10; B21D 53/76

(52) U.S. Cl. 399/238; 29/530

(57) ABSTRACT

A method for producing a low-cost developer container filled with developer, which is capable of stably preventing image density from being locally reduced even in the case where the entire replenishment developer is not dispersed uniformly, the developer container filled with developer, and a developer replenishing device and image forming apparatus that use this developer container filled with developer. In production of a developer container filled with developer, which has a pouch portion for containing a replenishment developer comprising a toner and a carrier, and a cap member for discharging the replenishment developer from the inside to the outside of the pouch portion, and which is mounted on a developer replenishing device that conveys the replenishment developer discharged from the cap member to a developing device, the toner and carrier are mixed together to produce a pre-mixed toner that has a carrier weight ratio lower than that of an initial developer filled into the developing device in the early stages, and the pouch portion is filled with the pre-mixed developer and the single toner separately.

### BACKGROUND OF THE INVENTION

1. Field of the Invention

The present invention relates to a method for producing a developer container filled with developer, which contains a replenishment developer consisting of a toner and a carrier, the developer container filled with developer, and a developer replenishing device and image forming apparatus that use this developer container filled with developer.

2. Description of the Related Art

In a conventional image forming apparatus that uses a two-component developer consisting of toner and magnetic carrier, because the toner within the developing device is consumed, a new replenishment toner is replenished into the developing device by the amount consumed. In this developing device, some of the developer is conveyed to a developing region for development as the entire developer is circulated and conveyed. In recent years, the amount of developer contained in a developing device is reduced due to the downsizing of an image forming apparatus, and the speed of the developer circulating in the developing device is in an increasing tendency due to the fast processing performed in the apparatus. For this reason, the coated layer on the surface of a carrier is scraped off due to the increase of the stress on the developer within the developing device, and spent toner component and the like easily accelerate the degradation of the carrier. When the carrier degrades in this manner, the deterioration of the image quality would be inevitable. In a conventional toner replenishing device for replenishing a replenishment toner into a developing device, a toner within the developing device is replaced but a carrier within the developing device is not replaced. Therefore, it is necessary to replace the carrier contained in the developing device in order to prevent the deterioration of the image quality caused by the degradation of the carrier. However, causing a serviceman to replace the carrier within the developing device on regular basis increases the maintenance cost.

As an example of the configuration that can prevent the deterioration of image quality caused by degraded carrier of a developing device while preventing the increase in the maintenance cost, a replenishing device described in Japanese Examined Patent Application Publication No. S60-18065 (Prior Art 1) is known. This replenishing device allows automatic replenishment of a replenishment carrier on regular basis independently from a replenishment toner. Then, carrier within the developing device is replaced by discharging a developer of an amount equivalent to the amount of replenished carrier from the developing device. In this manner, the proportion of deteriorated carrier within the developing device can be reduced, and the degradation of image quality caused by the deteriorated carrier of the developing device can be prevented. Consequently, the increase in the maintenance cost can be prevented because a serviceman no longer needs to replace the carrier of the developing device frequently. However, this replenishing device has a container for containing the replenishment toner and a container for containing the replenishment carrier as separate units. This replenishing device further has a replenishing mechanism for conveying the replenishment toner or replenishment carrier from the corresponding container to the developing device. Therefore, this replenishing device requires a large space therein and has a large number of components, causing an increase in the size of the device and production cost.

Also, Japanese Unexamined Patent Application Publication No. 2004-29306 (Prior Art 2) discloses a developer replenishing device that has a developer container which mixes replenishment toner with replenishment carrier beforehand, contains thus obtained replenishment developer having a toner density higher than that of a developer contained in a developing device, and replenishes this replenishment developer into the developing device. In this developer replenishing device, the carrier within the developing device is replaced by discharging a developer of an amount equivalent to the amount of replenished replenishment developer from the developing device. In this developer replenishing device, because it is not necessary to provide the container or replenishing mechanism for the replenishment toner or replenishment carrier, the size of the device can be made smaller and the production cost can be reduced, compared to the toner replenishing device of the Prior Art 1 described above.

On the other hand, as a toner replenishing device for replenishing replenishment toner to a developing device, the one described in Japanese Unexamined Patent Application Publication No. 2004-323062 (Prior Art 3) is known. This toner replenishing device uses the negative pressure of a powder pump to suction the replenishment toner contained in a toner container containing the replenishment toner, and conveys the suctioned replenishment toner to a developing device. More specifically, the toner replenishing device is provided with a conveyance path member through which the replenishment toner passes and the powder pump, wherein the negative pressure generated by the suction power of the powder pump is used to discharge the replenishment toner existing in the vicinity of a toner outlet of the toner container from the toner outlet. Then, the replenishment toner discharged from the toner outlet is then conveyed to the developing device by the negative pressure of the powder pump through the conveyance path member. In addition, because the toner container is configured by a flexible pouch-like member having a substantially sealed structure, the volume of the toner container is reduced as the replenishment toner existing in the vicinity of the toner outlet is discharged from the toner outlet. Therefore, as the replenishment toner in the vicinity of the toner outlet is discharged from the toner outlet, the rest of the replenishment toner contained in the toner container moves toward the toner outlet by the amount of the discharged replenishment toner. According to this toner container replenishing device, because the suction operation of the powder pump discharges the replenishment toner and moves the replenishment toner within the toner container, the toner container replenishing device does not require a mechanism for discharging the replenishment toner of the toner container or moving the replenishment toner toward the outlet within the toner container.

The developer replenishing device described in Prior Art 2 does not have a mechanism for agitating the replenishment developer in the developer container. Therefore, the toner and carrier have to be dispersed uniformly within the developer container so that the replenishment developer with a greater amount of carrier (replenishment developer with higher carrier weight ratio) is not replenished to the developing device. In this case, if the developer portion within the developing device to which the replenishment developer is replenished is conveyed to a developing region and used for development without being agitated, the density of the image portion corresponding to this developer portion becomes low locally due to the low toner density (toner weight ratio), thereby causing a deterioration in the image quality.

Particularly when images with high image area ratios are successively formed, the toner density of a developer portion of the developing device to which the replenishment developer is supplied is extremely low, and this developer portion to which the replenishment developer is replenished is carried on a developer carrier and conveyed to the developing region before going around in the developing device. In such a case, if the replenishment developer with higher carrier weight ratio (replenishment developer with lower toner density) is replenished, the developer portion within the developing device to which the replenishment developer is replenished cannot recover a sufficient toner density and is conveyed to the developing region without being agitated sufficiently. Therefore, this developer portion might be mixed with the rest of the developer before being conveyed to the developing region and thereby the toner density cannot be recovered. As a result, the above-mentioned deterioration of image quality occurs easily.

However, by providing the mechanism for agitating the replenishment developer within the developer container, the toner and carrier that are not dispersed uniformly at first can be dispersed uniformly by the agitating operation of this mechanism. Consequently, the replenishment developer with higher carrier weight ratio can be prevented from being replenished to the developing device. In this case, however, the number of components of the disposable developer container is increased and the production process thereof becomes complicated, resulting in the increase of production cost. Therefore, it is not preferred to provide such a mechanism.

As in the developer replenishing device described in Prior Art 2, the configuration that is not provided with the mechanism for agitating the replenishment developer of the developer container needs to prevent the replenishment developer with higher carrier weight ratio (replenishment developer with lower toner density) from being replenished at once, in order to prevent the deterioration of image quality caused by the local reduction of image quality. A considered method for avoiding such situation is a method for uniformly dispersing toner and carrier of the replenishment developer beforehand to fill the developer container. However, this method has the following drawbacks.

Specifically, since the disposable developer container is produced in large volume, considered is a production process of preparing a large quantity of replenishment developer before filling developer containers, and then distributing this large quantity of replenishment developer to each developer container to fill up the developer container with the replenishment developer. With this production process, high productivity can be realized, but it is extremely difficult to conduct a work of agitating the toner and carrier of such large quantity of replenishment developer until they are uniformly dispersed. Therefore, there is a drawback of causing the increase in the production cost.

On the other hand, there is considered a production process of preparing a replenishment developer every time when filling up each developer container, the replenishment developer having a mixture of toner and carrier agitated and dispersed uniformly, and then filling the developer containers with this prepared replenishment developer. With this production process, the toner and carrier within the entire replenishment developer filling the developer container can be dispersed uniformly, but this production process produces extremely low productivity, which leads to the increase in the production cost.

As described above, the method for uniformly dispersing the toner and carrier beforehand in the entire replenishment developer of the developer containers is not realistic. Therefore, it is desirable to take measures for preventing the replenishment developer with higher carrier weight ratio (replenishment developer with lower toner density) from being replenished at once in the case where the toner and carrier are not dispersed uniformly in the entire replenishment developer.

Technologies relating to the present invention are also disclosed in, e.g., Japanese Unexamined Patent Application Publication No. 2001-194860, Japanese Unexamined Patent Application Publication No. H09-166912, Japanese Unexamined Patent Application Publication No. H09-204105, Japanese Patent Application No. 3535298, Japanese Unexamined Patent Application Publication No. H09-244376, Japanese Unexamined Patent Application Publication No. H10-063074, Japanese Unexamined Patent Application Publication No. H10-063075, Japanese Unexamined Patent Application Publication No. H02-021591, Japanese Unexamined Patent Application Publication No. 2005-283685, Japanese Unexamined Patent Application Publication No. H11-167260, and Japanese Unexamined Patent Application Publication No. 2003-021952.

### SUMMARY OF THE INVENTION

The present invention was contrived in view of the above circumstances, and an object of the present invention is to provide a method for producing a low-cost developer container filled with developer, which is capable of stably preventing image density from being locally reduced even in the case where the entire replenishment developer is not dispersed uniformly, the developer container filled with developer, and a developer replenishing device and image forming apparatus that use this developer container filled with developer.

In aspect of the present invention, a method is provided for producing a developer container filled with developer. The container has a developer containing body for containing a replenishment developer comprising a toner and a carrier, and a developer discharge outlet for discharging the replenishment developer from the inside to the outside of the developer containing body. The container is mounted on a developer replenishing device that conveys the replenishment developer discharged from the developer discharge outlet to a developing device. The method comprising the steps of producing a pre-mixed developer that has a carrier weight ratio lower than that of an initial developer having a mixture of a toner and a carrier and filled into the developing device in an early stage; and filling the developer containing body with the pre-mixed developer and the single toner separately.

In another aspect of the present invention, a method is provided for producing a developer container filled with developer. The container has a developer containing body for containing a replenishment developer comprising a toner and a carrier, and a developer discharge outlet for discharging the replenishment developer from the inside to the outside of the developer containing body. The container is mounted on a developer replenishing device that conveys the replenishment developer discharged from the developer discharge outlet to a developing device. The method comprises the step of filling the developer containing body with a pre-mixed developer comprising an initial developer that is filled into the developing device in an early stage and with the single toner separately so that the pre-mixed developer does not exist alone in the vicinity of the developer discharge outlet inside the filled developer containing body, the pre-mixed developer.

In another aspect of the present invention, a developer container is filled with developer. The container has a developer containing body for containing a replenishment developer comprising a toner and a carrier, and a developer discharge outlet for discharging the replenishment developer from the inside to the outside of the developer containing body. The container is mounted on a developer replenishing device that conveys the replenishment developer discharged from the developer discharge outlet to a developing device. The developer containing body is filled with the single toner and a pre-mixed developer that has a carrier weight ratio lower than that of an initial developer having a mixture of a toner and a carrier and filled into the developing device in an early stage.

In another aspect of the present invention, a developer container is filled with developer. The container has a developer containing body for containing a replenishment developer comprising a toner and a carrier, and a developer discharge outlet for discharging the replenishment developer from the inside to the outside of the developer containing body. The container is mounted on a developer replenishing device that conveys the replenishment developer discharged from the developer discharge outlet to a developing device. The developer containing body is filled with a pre-mixed developer comprising an initial developer that is filled into the developing device in an early stage and with the single toner so that the pre-mixed developer does not exist alone in the vicinity of the developer discharge outlet inside the developer containing body.

In another aspect of the present invention, a developer replenishing device comprises a developer containing body for containing a replenishment developer comprising a toner and a carrier; and a developer conveying device for conveying the replenishment developer contained in the developer containing body to a developing device. The developer conveying device has a conveyance path member through which the replenishment developer passes, and a powder pump for generating negative pressure in the replenishment developer contained in the developer containing body and moving the replenishment developer to the developing device via the conveyance path member. The developer containing body is filled with the single toner and a pre-mixed developer that has a carrier weight ratio lower than that of an initial developer having a mixture of a toner and a carrier and filled into the developing device in an early stage.

In another aspect of the present invention, an image forming apparatus comprises a latent image carrier; a developing device that uses a developer contained in a developer containing body to develop a latent image formed on the latent image carrier and a developer replenishing device for replenishing a replenishment developer into the developer containing body. The developer replenishing device comprises a developer container for containing a replenishment developer comprising a toner and a carrier; and a developer conveying device for conveying the replenishment developer contained in the developer container to the developing device. The developer conveying device has a conveyance path member through which the replenishment developer passes, and a powder pump for generating negative pressure in the replenishment developer contained in the developer container and moving the replenishment developer to the developing device via the conveyance path member.

### BRIEF DESCRIPTION OF THE DRAWINGS

The above and other objects, features and advantages of the present invention will become more apparent from the following detailed description taken with the accompanying drawings, in which:

FIG. 1 is a diagram showing a schematic configuration of a copying machine functioning as an image forming apparatus according to Embodiment 1 of the present invention;

FIG. 2 is a diagram showing a schematic configuration of a developer replenishing device of the copying machine;

FIG. 3 is a diagram showing an exploded state of a developer container that is set up on the developer replenishing device;

FIG. 4 is a diagram showing a state in which the developer container is used up;

FIG. 5 is a diagram showing another example of a developing device applicable to the copying machine, along with a photoreceptor;

FIG. 6 is a perspective cross-sectional view for explaining how a developer flows in a developer conveyance path of the developing device;

FIG. 7 is a schematic diagram showing how the developer flows in the developing device;

FIG. 8 is a cross-sectional diagram showing the cross section of the rotation center of a supply screw of the developing device, the cross section being taken along the direction of the arrow J of FIG. 6;

FIG. 9 is a diagram showing the configuration of a developer filling device for filling the developer container with the replenishment developer;

FIGS. 10A to 10C are each a graph showing measurement results obtained when measuring a detected-pattern adhesion amount in experiments in which images with high image area ratios are successively formed using replenishment developers having different carrier weight ratios;

FIG. 11 is a graph showing a measurement result obtained when measuring toner density in the same experiment;

FIG. 12 is a perspective view showing the configuration of a developer replenishing device provided in a copying machine of Embodiment 2 of the present invention;

FIG. 13 is a diagram showing a schematic configuration of the developer replenishing device;

FIG. 14 is a perspective view showing the appearance of a developer container according to Embodiment 2;

FIG. 15 is a diagram for explaining how the developer container for a color K is set up; and

FIG. 16 is a perspective view showing the appearance of the copying machine to explain how the developer container for the color K is set up.

### DESCRIPTION OF THE PREFERRED EMBODIMENT(s)

As an image forming apparatus to which the present invention is applied, embodiments of a tandem color laser copying machine (simply called “copying machine” hereinafter) in which a plurality of photoreceptors are disposed in parallel with each other will now be described hereinafter.

### Embodiment 1

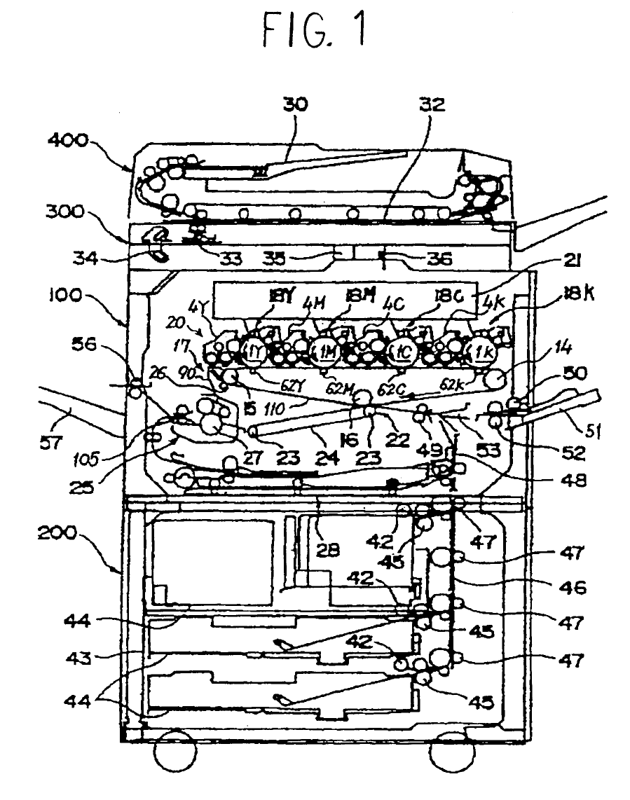

FIG. 1 shows a schematic configuration of a copying machine according to Embodiment 1 of the present invention.

This copying machine has a printer portion 100, a sheet feeding device 200 on which the printer portion 100 is placed, a scanner 300 placed fixedly on the printer portion 100, and the like. The copying machine also has an automatic original conveying device 400 that is placed fixedly on the scanner 300.

The printer portion 100 has an image forming unit 20 that is constituted by four process cartridges 18Y, 18M, 18C and 18K for forming images of colors of yellow (Y), magenta (M), cyan (C), and black (K) respectively. Y, M, C and K provided at the ends of the reference numerals indicate the members for the colors, yellow, cyan, magenta and black, respectively (same hereinafter). In addition to the process cartridges 18Y, 18M, 18C and 18K, an optical writing unit 21, an intermediate transfer unit 17, a secondary transfer device 22, a resist roller pair 49, a belt fixing type fixing device 25 and the like are disposed in the printer portion 100.

The optical writing unit 21 has a light source, a polygon mirror, an f-θ lens, a reflecting mirror and the like, which are not shown, so as to emit a laser beam onto the surface of an after-described photoreceptor on the basis of image data.

Each of the process cartridges 18Y, 18M, 18C and 18K has a drum-like photoreceptor 1, a charging unit, a developing device 4, a drum cleaning device, a destaticizing unit, and the like.

The yellow process cartridge 18 will be described hereinafter.

The surface of a photoreceptor 1Y is uniformly charged by the charging unit functioning as charging means. The surface of the photoreceptor 1Y that is subjected to the charging processing is irradiated with a laser beam that is modulated and deflected by the optical writing unit 21. Consequently, the potential of the irradiated portion (exposed portion) is attenuated. Due to this attenuation, a Y electrostatic latent image is formed on the surface of the photoreceptor 1Y. The formed Y electrostatic latent image is developed into a Y toner image by a developing device 4Y functioning as developing means.

The Y toner image formed on the Y photoreceptor 1Y is primarily transferred to an intermediate transfer belt 110 which is described hereinafter. The transfer residual toner on the surface of the photoreceptor 1Y posterior to the primary transfer is cleaned by the drum cleaning device.

In the Y process cartridge 18Y, the photoreceptor 1Y that is cleaned by the drum cleaning device is destaticized by the destaticizing unit. Then, the photoreceptor 1Y is uniformly charged by the charging unit and thereby returns to the initial state. The series of processes described above is the same for the other process cartridges 18M, 18C and 18K.

The intermediate transfer unit will now be described.

The intermediate transfer unit 17 has the intermediate transfer belt 110, a belt cleaning device 90 and the like. The intermediate transfer unit 17 further has a stretching roller 14, a drive roller 15, a secondary transfer backup roller 16, four primary transfer bias rollers 62Y, 62M, 62C and 62K, and the like.

The intermediate transfer belt 110 is tension-stretched by a plurality of rollers including the stretching roller 14. The intermediate transfer belt 110 is then moved endlessly in a clockwise direction in the drawing by the rotation of the drive roller 15 that is driven by a belt drive motor, which is not shown.

Each of the four primary transfer bias rollers 62Y, 62M, 62C and 62K is disposed in contact with the inner peripheral surface of the intermediate transfer belt 110, and is applied with a primary transfer bias from a power source, which is not shown. Furthermore, the inner peripheral surface of the intermediate transfer belt 110 is pressed against the photoreceptors 1Y, 1M, 1C and 1K to form primary transfer nips. At each of the primary transfer nips, a primary transfer electric field is formed between each photoreceptor 1 and each primary transfer bias roller 62 due to the influence of the primary transfer bias.

The abovementioned Y toner image formed on the Y photoreceptor 1Y is primarily transferred onto the intermediate transfer belt 110 due to the influence of the primary transfer electric field or nip pressure. M, C and K toner images formed on the respective M, C and K photoreceptors 1M, 1C and 1K are sequentially superimposed and primarily transferred onto the Y toner image. A four-color superimposed toner image (called “four-color toner image” hereinafter), i.e., the multiple toner images, is formed on the intermediate transfer belt 110 due to the primary transfer performed subsequently to the superimposed toner images.

The four-color toner image that is transferred onto the intermediate transfer belt 110 is secondarily transferred onto a transfer sheet, i.e., a recording medium that is not shown, by a secondary transfer nip described hereinafter. The residual transfer toner that remains on the surface of the intermediate transfer belt 110 after the four-color toner image passes through the secondary transfer nip is cleaned by the belt cleaning device 90 that holds the belt between this belt cleaning device and the drive roller 15 located on the left side of the drawing.

The secondary transfer device 22 will be described next.

The secondary transfer device 22 that stretches a sheet conveying belt 24 by means of two stretching rollers 23 is disposed on the lower side of the intermediate transfer unit 17 as shown. The sheet conveying belt 24 is endlessly moved in a counterclockwise direction in the drawing as at least either one of the stretching rollers 23 is driven to rotate. Of the two stretching rollers 23, the one roller disposed on the right side in the drawing holds the intermediate transfer belt 110 and the sheet conveying belt 24 between this stretching roller 23 and the secondary backup roller 16 of the intermediate transfer unit 17. Accordingly, the secondary transfer nip where the intermediate transfer belt 110 of the intermediate transfer unit 17 comes into contact with the sheet conveying belt 24 of the secondary transfer device 22 is formed. Then, this stretching roller 23 is applied with a secondary transfer bias having a polarity opposite to the polarity of the toner, by the power source that is not shown. Due to this application of the secondary transfer bias, a secondary transfer electric field that electrostatically moves the four-color toner image formed on the intermediate transfer belt 110 of the intermediate transfer unit 17 from the belt side toward this stretching roller 23 is formed at the secondary transfer nip. The four-color toner image that is affected by the secondary transfer electric field or nip pressure is secondarily transferred onto the transfer sheet, which is sent to the secondary transfer nip by the after-described resist roller pair 49 in synchronization with the four-color toner image formed on the intermediate transfer belt 110. It should be noted that a charger for charging the transfer sheet in a noncontact manner may be provided in place of the secondary transfer system that applies a secondary transfer bias to this stretching roller 23.

In the sheet feeding device 200 provided in a lower section of the main body of the copying machine, a plurality of sheet feeding cassettes 44, each of which can contain a plurality of stacked transfer sheets, are disposed vertically in a stacked manner. Each of the sheet feeding cassettes 44 presses the top transfer sheet of the stacked transfer sheets against a sheet feeding roller 42. Then, by rotating the sheet feeding roller 42, the top transfer sheet is sent out toward a sheet feeding path 46.

The sheet feeding path 46 that receives the transfer sheet from the sheet feeding cassette 44 has a plurality of conveying roller pairs 47 and the resist roller pair 49 that is provided in the vicinity of an end of the sheet feeding path 46. The sheet feeding path 46 conveys the transfer sheet toward the resist roller pair 49. The transfer sheet conveyed toward the resist roller pair 49 is sandwiched between the roller portions of the resist roller pair 49. On the other hand, in the intermediate transfer unit 17, the four-color toner image formed on the intermediate transfer belt 110 enters the secondary transfer nip as the belt endlessly moves. The resist roller pair 49 sends the transfer sheet, which is sandwiched between the roller portions, at timing at which the transfer sheet is attached to the four-color toner image at the secondary transfer nip. In this manner, the four-color toner image formed on the intermediate transfer belt 110 is attached to the transfer sheet at the secondary transfer nip. Then, the four-color toner image is secondarily transferred onto the transfer sheet and thereby becomes a full-color image on the white transfer sheet. The transfer sheet on which the full-color image is formed in this manner leaves the secondary transfer nip as the sheet conveying belt 24 endlessly moves, and is then sent from the top of the sheet conveying belt 24 to the fixing device 25.

The fixing device 25 has a belt unit that is caused to move endlessly while stretching a fixing belt 26 by means of two rollers, and a pressure roller 27 that is pressed against one of the rollers of the belt unit. The fixing belt 26 and the pressure roller 27 abut against each other to form a fixing nip, and the transfer sheet received from the sheet conveying belt 24 is sandwiched by this nip. Of the two rollers of the belt unit, the roller that is pressed by the pressure roller 27 has a heat source therein, which is not shown, so as to heat the fixing belt 26 by using heat generated by the heat source. The heated fixing belt 26 then heats the transfer sheet sandwiched by the fixing nip. Due to the application of heat or the nip pressure, the full-color image is fixed on the transfer sheet.

The transfer sheet that is subjected to the fixing processing in the fixing device 25 is either stacked on a stack portion 57 provided outside of a plate of a printer casing on the left side of the drawing, or is returned to the abovementioned secondary transfer nip in order to form a toner image on the other side of the transfer sheet.

When making a copy of an original, which is not shown, for example, a sheaf of sheet originals is set on an original platen 30 of the automatic original conveying device 400. However, if the originals are one-filing originals closed by the subject document, the sheaf of sheet originals is set on a contact glass 32. Prior to this setting operation, the automatic original conveying device 400 is opened with respect to the copying machine main body, and thereby the contact glass 32 of the scanner 300 is exposed. Thereafter, the one-filing originals are pressed and held by the closed automatic original conveying device 400.

After the originals are set in this manner, a copy start switch, not shown, is pressed, whereby an original reading operation is performed by the scanner 300. However, if the sheet originals are set on the automatic original conveying device 400, the automatic original conveying device 400 automatically moves the sheet originals to the contact glass 32 prior to the original reading operation. In the original reading operation, a first traveling body 33 and a second traveling body 34 start traveling together first, and light is emitted from a light source provided in the first traveling body 33. Then, the light reflected from the surface of the originals is reflected by a mirror provided within the second traveling body 34, passes through an image forming lens 35, and thereafter enters a read sensor 36. The read sensor 36 constructs image information based on the incident light.

In parallel with this original reading operation, each element within each of the process cartridges 18Y, 18M, 18C and 18K, the intermediate transfer unit 17, the secondary transfer device 22, and the fixing device 25 start driving. Then, the optical writing unit 21 is driven and controlled based on the image information constructed by the read sensor 36, and Y, M, C and K toner images are formed on the photoreceptors 1Y, 1M, 1C and 1K respectively. These toner images become the four-color toner image by superimposing and transferring these toner images on the intermediate transfer belt 110.

Moreover, at substantially the same time as when the original reading operation is performed, a sheet feeding operation is started in the sheet feeding device 200. In this sheet feeding operation, one of the sheet feeding rollers 42 is selected and rotated, and transfer sheets are sent out from one of the sheet feeding cassettes 44 that are stored in multiple stages in a sheet bank 43. The sent transfer sheets are separated one by one by a separation roller 45. Each sheet enters a reversal sheet feeding path 46 and is then conveyed to the secondary transfer nip by the conveying roller pairs 47. A manual tray 51 sometimes feeds the sheets in substitution for the sheet feeding cassettes 44. In this case, after a manual sheet feeding roller 50 is selected and rotated to send out transfer sheets placed on the manual tray 51, a separation roller 52 separates the transfer sheets one by one and feeds each sheet to a manual sheet feeding path 53 of the printer portion 100.

In this present copying machine, when forming a color image composed of toners of two or more colors, the intermediate transfer belt 110 is stretched such that an upper stretching surface thereof lies substantially horizontally, and all of the photoreceptors 1Y, 1M, 1C and 1K are brought into contact with the upper stretching surface. On the other hand, when forming a monochrome image composed of the K toner only, the intermediate transfer belt 110 is tilted downward to the left in the drawing by using a mechanism, which is not shown, and the upper stretching surface is separated from the Y, M and C photoreceptors 1Y, 1M and 1C. Then, out of the four photoreceptors 1Y, 1M, 1C and 1K, only the K photoreceptor 1K is rotated in the counterclockwise direction in the drawing to form a K toner image only. At this moment, for Y, M and C, driving of the respective photoreceptor 1 and of the developing device 4 is stopped to prevent the photoreceptor and developer from being depleted unnecessarily.

The copying machine has a control unit, not shown, which is configured by a CPU and the like that control the elements within the copying machine, and an operation display portion, not shown, which is configured by a liquid crystal display, various keybuttons, and the like. An operator can select one of three one-side printing modes for forming an image on one side of a transfer sheet, by sending a command to the control unit based on the implementation of a key input operation in the operation display portion. The three one-side printing modes are a direct discharge mode, a reversal discharge mode, and a reversal decal discharge mode.

A developer replenishing device will now be described.

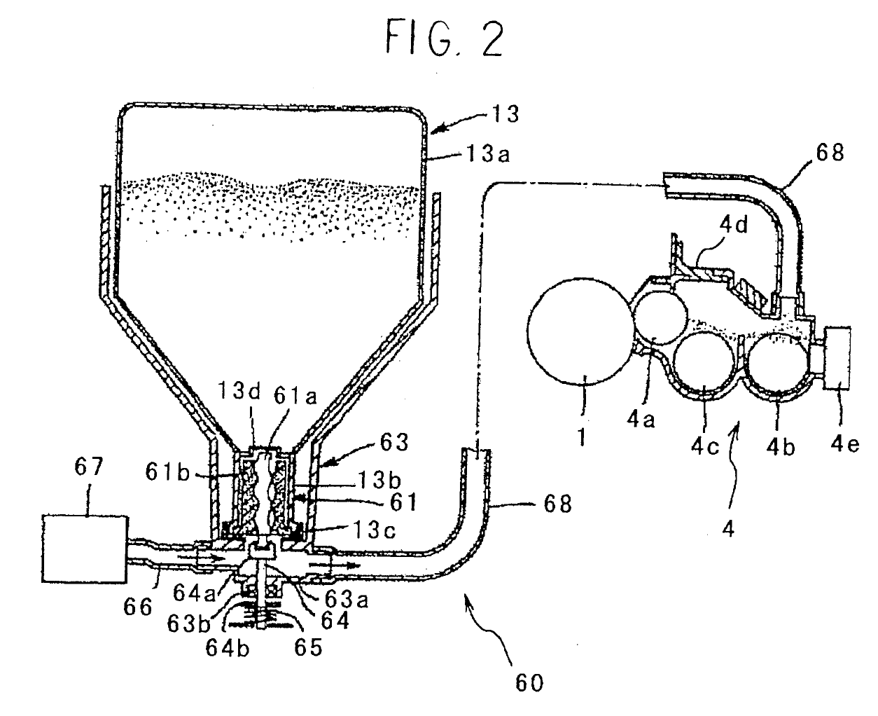

FIG. 2 is an explanatory diagram showing a schematic configuration of a developer replenishing device provided in each of the four process cartridges 18Y, 18M, 18C and 18K.

Four developer replenishing devices corresponding to the four process cartridges 18Y, 18M, 18C and 18K respectively have substantially the same configuration other than the fact that the toner colors to be used are different. Therefore, one of the developer replenishing devices will be described as an example. Note that the suffix letters Y, M, C and K are omitted in the following descriptions.

A developer replenishing device 60 suctions a replenishment developer contained in a developer container 13 by using the suction power of a powder pump 61, and conveys the replenishment developer to the developing device 4 via a transport tube 68. For the transport tube 68, it is extremely effective to use, for example, polyurethane, nitrile, EPDM, silicon, or other rubber material that is in the form of a flexible tube with an inner diameter of 4 to 10 mm and excellent in toner resistance properties.

The developing device 4 is described simply herein. The developing device 4 has a developing sleeve 4a serving as a developer carrier that is disposed to face the photoreceptor 1, and a first agitating screw 4b and a second agitating screw 4c that serve as agitating/conveying members. Developer within the developing device 4 is circulated and conveyed in the developing device by the first agitating screw 4b and second agitating screw 4c, and carried on the surface of the developing sleeve 4a in a conveyance path provided with the second agitating screw 4c. The developer that is carried on the surface of the developing sleeve 4a is conveyed to a developing region facing the photoreceptor 1 as the surface of the developing sleeve 4a moves. The developer is then used for development. Also, an air filter 4d is provided in an upper part of the developing sleeve 4a so that the air within the developing device can be let out of the device via this air filter 4d. The developing device 4 is further provided with a toner density sensor (magnetic permeability sensor) 4e for detecting the toner density of the developer contained in the developing device.

In the developer replenishing device 60, the developer container 13 is mounted in a detachable manner. This developer container 13 has a pouch portion 13a as a developer containing body that is configured by a flexible and deformable pouch-like member. This pouch portion 13a is in the shape of a pouch container with a single layer or multiple layers of flexible sheet materials (having a thickness of approximately 80 to 125 μm) made of a polyester film, polyethylene film or the like. This pouch portion 13a is tapered at the lower portion thereof to have the shape of a mortar, and an opening is formed on a lower leading end thereof. A mouthpiece member 13b that functions as a developer outlet made of a resin such as a polyethylene and Nylon™ is fixed to this opening.

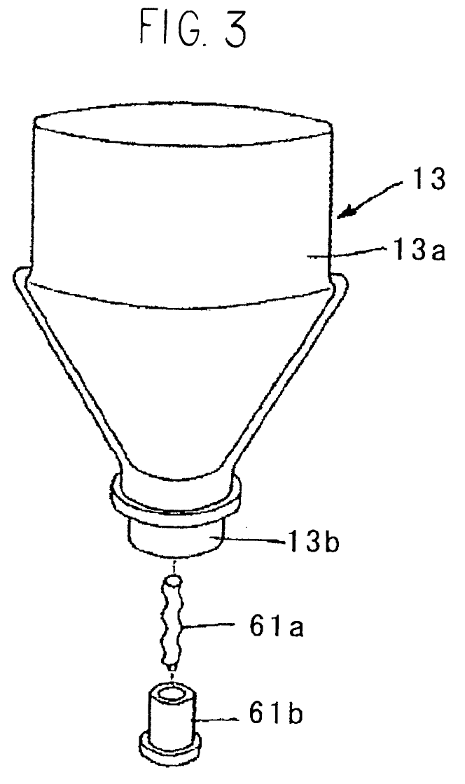

The powder pump 61 of the developer replenishing device 60 is detachably mounted on a hollow portion of the mouthpiece member 13b, which is a hollow cylindrical member. The powder pump 61, which is an ejection-type uniaxial eccentric screw pump, has a rotor 61a that is formed into an eccentric screw with metal or other rigid material, and a stator 61b, the interior portion of which is formed into a double-threaded screw with rubber or other elastic material so as to be fixed and installed to the rotor 61a. When mounting the developer container 13 to the developer replenishing device 60, the stator 61b of the powder pump 61 is fitted into the mouthpiece member 13b of the developer container 13 from underneath, whereby the stator 61b is held at this fitting position by a receiving member 13c of the developer container 13. The receiving member 13c is secured to the mouthpiece member 13b in a removable manner by screwing or engaging it into the mouthpiece member 13b, so that the stator 61b and rotor 61a can be detached from the developer container 13 by removing the receiving member 13c, as shown in FIG. 3. Moreover, the mouthpiece member 13b is provided with a stopper 13d which prevents the rotor 61a from slipping into the pouch portion 13a. Note that the stopper 13d may be provided with a shaft bearing for rotatably supporting the rotor 61a.

A set portion 63 on which the developer container 13 is set up is provided with a drive shaft 64 that extends in the vertical direction. This drive shaft 64 is supported on a lower member 63a of the set portion 63 by a shaft bearing 63b so as to be able to rotate freely and move vertically and is driven to rotate by a drive source that is not shown. A joint 64a that can be engaged with the rotor 61a is secured to a leading end (upper end) of the drive shaft 64. Also, the drive shaft 64 is urged upward by a spring 65. In a state in which the developer container 13 is not set up on the set portion 63, the drive shaft 64 stands in a position where a clamping plate 64b, which is secured to the drive shaft 64, abuts on a lower surface of the shaft bearing 63b. Then, once the developer container 13 is set up on the set portion 63, the rotor 61a provided in the mouthpiece member 13b of the developer container 13 is brought into engagement with the joint 64a to push the drive shaft 64 down against the urging force of the spring 65. The engagement between the joint 64a and the rotor 61a is maintained by the urging force of the spring 65.

A lower end surface of the set portion 63 is communicated with a pipe portion 66 that extends in a horizontal direction in the drawing, and thus the replenishment developer that is discharged from the developer container 13 by the powder pump 61 falls down into the pipe portion 66. One end of this pipe portion 66 is connected to the transport tube 68 and then communicated with the developing device 4 via this transport tube 68. Furthermore, the other end of the pipe portion 66 is connected an air pump 67 that functions as air supply means. The replenishment developer that falls down into the pipe portion 66 is conveyed to the developing device 4 via the transport tube 68 by an air current sent from the air pump 67.

It is known that the uniaxial eccentric screw pump functioning as the powder pump 61 can successively transport a fixed amount of powder at a high solid-gas ratio and that an accurate amount of replenishment developer that is proportional to the rotation speed of the rotor 61a can be transported. Therefore, the rotation speed and drive time of the powder pump 61 may be controlled in order to control the amount of replenishment developer to be transported. When the rotor 61a rotates, the powder pump 61 generates a downward ejection pressure and an upward suction pressure. The magnitude of the ejection pressure or suction pressure relies on the shapes of the rotor 61a and stator 61b of the powder pump 61 and the rotation speed of the rotor 61a. In Embodiment 1, since the transport tube 68 is flexible and the replenishment developer is transported by the air current sent from the air pump 67, the degree of freedom in the transportation through the transport path 68 is extremely high, so that the replenishment developer can be transported freely any of the vertical and horizontal directions. Moreover, because it is sufficient that the amount of air supplied by the air pump 67 is as small as a maximum flow (unloaded condition) of 1 to 2 litters/min, the air within the developing device 4 can be released easily and the occurrence of toner scattering can be prevented easily.

In addition, the powder pump 61 plays a role of a self-closing valve that completely closes when the device is stopped. Therefore, in a state in which the developer container 13 is removed from the set portion 63, the mouthpiece member 13b of the developer container 13 is sealed so that the replenishment developer contained in the developer container 13 does not spatter to the outside. Consequently, the replenishment developer can be securely prevented from spattering and contaminating the equipment and the like during replacement of the developer container 13.

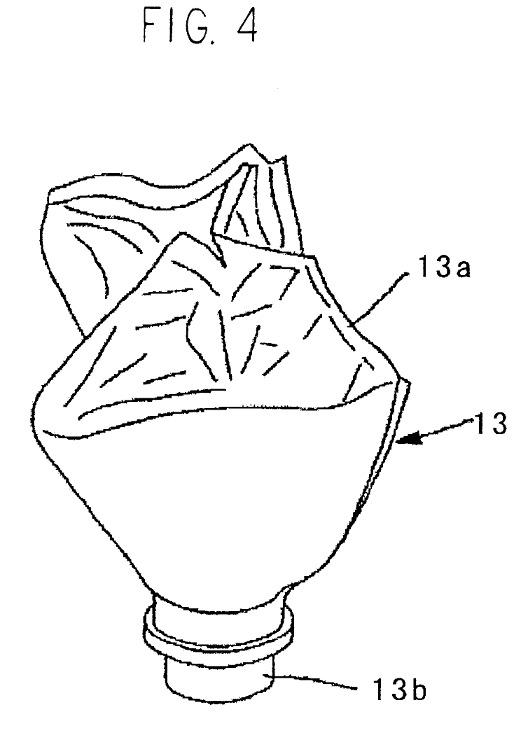

In addition, because the pouch portion 13a of the developer container 13 is a sealed pouch-like member made of a flexible material, the volume of the pouch portion 13a of the developer container 13 is gradually reduced as the replenishment developer is discharged by the powder pump 61. Therefore, when the replenishment developer contained in the pouch portion 13a of the developer container 13 is completely discharged, the volume of the pouch portion 13a is reduced as shown in FIG. 4, and then the pouch portion 13a can be collected and disposed. Specifically, in the case where 90% of the volume of the pouch portion 13a of the initial developer container 13 is filled with the replenishment developer, the pouch portion 13a is automatically squashed into the first 10% of the volume by the time when the replenishment developer is used up. Unlike those hard bottles such as the conventional cartridges and bottles, the advantage of such a flexible developer container 13 is its handling performance when being carried or stored because they do not take up much space. The used developer containers 13 are picked up from a user by the manufacturer of the developer containers 13 and then subjected to incineration or recycled/reused. In so doing, the abovementioned advantage, which is that the present developer container 13 has an excellent handling performance when being carried or stored because it can be rolled or folded into any shape and thus does not take up much space, becomes notable; which leads to a significant reduction of the cost for collecting/distributing the used developer containers 13 from the user. In addition, since the powder pump 61 can be detached from the developer container 13 according to Embodiment 1, the powder pump 61 can be recycled/reused easily. Note that the life of the powder pump 61 ends when the rubber stator 61b becomes worn, but in this case the rotor 61a can be used repeatedly by simply replacing the stator 61b only.

Also, since the lower portion of the pouch portion 13a of the developer container 13 is tapered into a mortar toward the mouthpiece member 13b, the replenishment developer contained in the pouch portion 13a can be moved smoothly toward the mouthpiece member 13b.

The present developer replenishing device is controlled by controlling the drive of the powder pump 61 and the drive of the air pump 67 by using a controller having an MPU which is not shown. The drive control can be used in a wide variety of known technologies. In Embodiment 1, replenishment of the replenishment developer is controlled based on a result of detection performed by the toner density sensor 4e provided in the developing device 4, by using a method for controlling the replenishing amount of the replenishment developer so that the toner density associated with the detection result approaches a target toner density. As the method for controlling the replenishment of the replenishment developer, it is possible to use a method for using an optical sensor or the like to detect the density of a detection toner image formed on the surface of the photoreceptor 1 or intermediate transfer belt 110 and then controlling the replenishing amount of the replenishment developer so that reflection density associated with a result of the detection approaches a target reflection density.

In the replenishment control according to Embodiment 1, the controller that loads the result of the detection performed by the toner density sensor 4e controls the drive source or drive transmission means (clutch or the like) (both not shown) in response to this detection result, drives the powder pump 61 through the drive shaft 64, and transmits an operation signal to the air pump 67 to drive the air pump 67. The controller of Embodiment 1 has a timer function so as to be able to control the drive of the drive source or air pump 67 in any point of timing. The controller starts activating the rotor 61a of the powder pump 61 and the air pump 67 simultaneously and activates them individually for a predetermined time. Consequently, a predetermined amount of replenishment developer is discharged from the developer container 13 and sent to the developing device 4 via the transport tube 68. The air pump 67 is configured such that it is further activated for an extra amount of time after the rotor 61a of the powder pump 61 is stopped, and then stopped. In this manner, the whole replenishment developer that is discharged from the developer container 13 by powder pump 61 can be conveyed to the developing device 4. Also, since the replenishment developer does not remain in the transport tube 68 at all, clogging of the transport tube 68 can be prevented.

As the developer container of Embodiment 1, it is possible to use a developer container that is similar to a conventional toner container constructed by integrating blow-molded mouthpiece portion and toner storage.

Next, another example of a possible developing device will be described as the developing device of Embodiment 1.

This developing device has: a developing sleeve, which rotates while carrying a two-component developer consisting of toner and magnetic carrier on a surface thereof, supplies the toner to a latent image on a surface of a latent image carrier at a section where the developing sleeve faces the latent image carrier, and develops the latent image; a developer supply conveyance path, which has a developer supplying/conveying member conveying the developer along a direction of axis of the developing sleeve and supplying the developer to the developing sleeve; a developer recovery conveyance path, which has a developer recovering/conveying member for conveying, in the direction of axis of the developing sleeve and a direction same as the direction of the developer supplying/conveying member, the developer that has passed through the section where the developing sleeve faces the latent image carrier and is then recovered from above the developing sleeve; and a developer agitation conveyance path, which receives a supply of an excess developer conveyed to the lowermost stream side of the developer supply conveyance path in a conveyance direction without being used in development, and a recovery developer recovered from the developing sleeve and conveyed to the lowermost stream side of the developer recovery conveyance path in the conveyance direction, and conveys the excess developer and the recovery developer in the direction of axis of the developing sleeve and in a direction opposite to the direction of the developer supplying/conveying member while agitating the excess developer and the recovery developer, and which supplies the developer to the developer supply conveyance path, wherein the three developer conveyance paths, i.e., the developer recovery conveyance path, the developer supply conveyance path and the developer agitation conveyance path, are partitioned by partition walls, the developer agitation conveyance path and the developer recovery conveyance path are provided on substantially the same level, and the developer supply conveyance path is positioned above the other two developer conveyance paths. In this developing device in which the toner is replenished to the developer conveyance paths, the developer supply conveyance path is provided obliquely above the developer agitation conveyance path.

In this developing device, it is preferred that an upper wall surface of the developer agitation conveyance path be disposed higher than a lower wall surface of the developer supply conveyance path.

Also, it is preferred that the developer supply conveyance path and the developer agitation conveyance path be disposed such that the center distance between the developing sleeve and the developer supply conveyance path is shorter than the center distance between the developing sleeve and the developer agitation conveyance path.

In addition, the three developer conveying members, i.e., the developer supplying/conveying member, the developer recovering/conveying member and the developer agitating/conveying member, are each a developer conveying screw that has a spiral wing on its rotation axis and uses this wing to convey the developer by rotating. It is preferred that these three developer conveying members be a developer supplying screw, a developer recovery screw and a developer agitating screw, respectively. Particularly, the direction of rotation and the shape of the developer agitating screw may be set so as to be able to lift the developer from the developer agitation conveyance path to the developer supply conveyance path from a place near the developing sleeve.

Specific examples of these developer conveyance paths are described hereinafter.

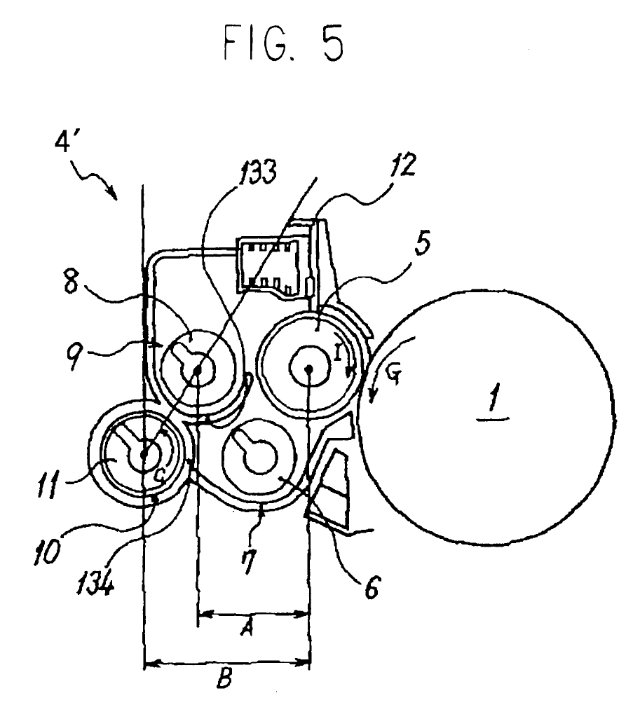

FIG. 5 shows the configurations of a developing device 4′ and of the photoreceptor 1.

The surface of the photoreceptor 1 is charged by the charging device (not shown) as it rotates in the direction of the arrow G in the drawing shown in FIG. 5. The toner is supplied from the developing device 4′ to a latent image, which is formed as an electrostatic latent image on the charged surface of the photoreceptor 1 by a laser beam irradiated from an exposure device (not shown), whereby a toner image is formed. A developing roller 5 of the developing device 4′ supplies the toner to the latent image formed on the surface of the photoreceptor 1, while surface-moving in the direction of the arrow I of the drawing.

The developing device 4′ also has a supply screw 8 serving as a supplying/conveying member for, while supplying the developer to the developing roller 5, conveying the developer in the direction toward the far side the drawing. A doctor blade 12 serving as a developer regulating member for regulating the thickness of the developer supplied to the developing roller 5 to a thickness suitable for development is provided on the downstream side in the direction of surface movement of the developing roller 5 from a part where the developing roller 5 faces the supply screw 8. A recovery screw 6 serving as the developer recovering/conveying member, which recovers the developer that passes through a developing region and is used for development, and further conveys the recovered recovery developer in the same direction as the direction of the supply screw 8, is provided on the downstream side in the direction of surface movement from the developing region which is a region where the developing roller 5 faces the photoreceptor 1. A supply conveyance path 9 having the supply screw 8 and serving as the developer supply conveyance path is disposed in substantially the horizontal direction of the developing roller 5, while a recovery conveyance path 7 having the recovery screw 6 and serving as the developer recovery conveyance path is disposed obliquely below the developing roller 5 in parallel with the supply conveyance path 9.

An agitation conveyance path 10 is provided below the supply conveyance path 9 in the developing device 4′ in parallel with the recovery conveyance path 7. The agitation conveyance path 10 has an agitating screw 11 that serves as a agitating/conveying member for conveying the developer in the opposite direction to the direction of the supply screw 8 while agitating the developer, the opposite direction being oriented on the near side in the drawing. The supply conveyance path 9 and the agitation conveyance path 10 are partitioned by a first partition wall 133 serving as a partition member. In a part of the first partition wall 133 that partitions the supply conveyance path 9 and the agitation conveyance path 10, an opening portion is formed at both ends in the near side and far side of the drawing to thereby allow the supply conveyance path 9 and the agitation conveyance path 10 to be communicated with each other. Note that although the supply conveyance path 9 and the recovery conveyance path 7 are also partitioned by the first partition wall 133, there is no opening portion provided in the part of the first partition wall 133 that partitions the supply conveyance path 9 and the recovery conveyance path 7. The two developer conveyance paths of the agitation conveyance path 10 and the recovery conveyance path 7 are also partitioned by a second partition wall 134 serving as a partition member. An opening portion is formed in the second partition wall 134 at the near side in the drawing to allow the agitation conveyance path 10 and the recovery conveyance path 7 to be communicated with each other. The supply screw 8, the recovery screw 6 and the agitating screw 11 are made of resin or metal. The diameter of each screw is set to φ22 [mm]. The supply screw is in the form of a double-thread screw and has a screw pitch of 50 [mm], and the recovery screw 6 and the agitating screw 11 each is in the form of a single-thread screw and has a screw pitch of 25 [mm]. The rotation speed of each screw is set to approximately 600 [rpm].

The developer that is thinned by the stainless doctor blade 12 on the developing roller 5 is conveyed to the developing region where the developing roller 5 faces the photoreceptor 1, and then development is performed. The surface of the developing roller 5 made of an Al or SUS pipe stock with a diameter of φ25 [mm] has a V-shaped groove or is sandblasted. The size of the gaps formed between the surface of the developing roller 5 and the doctor blade 12 and between the surface of the developing roller 5 and the photoreceptor 1 are approximately 0.3 [mm]. The developer obtained after the development is recovered by the recovery conveyance path 7, then conveyed to the near side of the cross section of FIG. 5, and then transferred to the agitation conveyance path 10 at the opening portion of the first partition wall 133 provided in a non-image region. Note that toner is supplied from a toner replenishing port to the agitation conveyance path 10, the toner replenishing port being provided above the agitation conveyance path 10 and in the vicinity of the opening portion of the first partition wall 133 on the upstream side in a developer conveyance direction in the agitation conveyance path 10.

Next, the circulation of the developer within the three developer conveyance paths will be described.

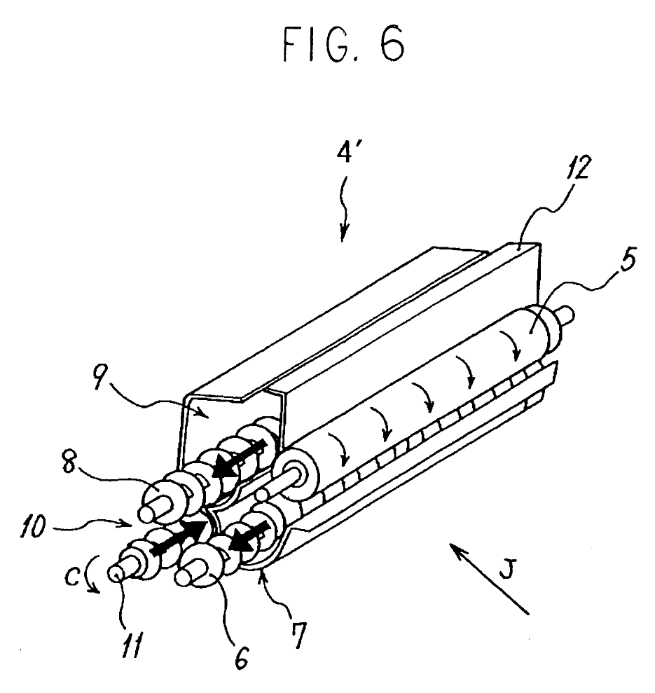

FIG. 6 shows how the developer flows in the developer conveyance paths.

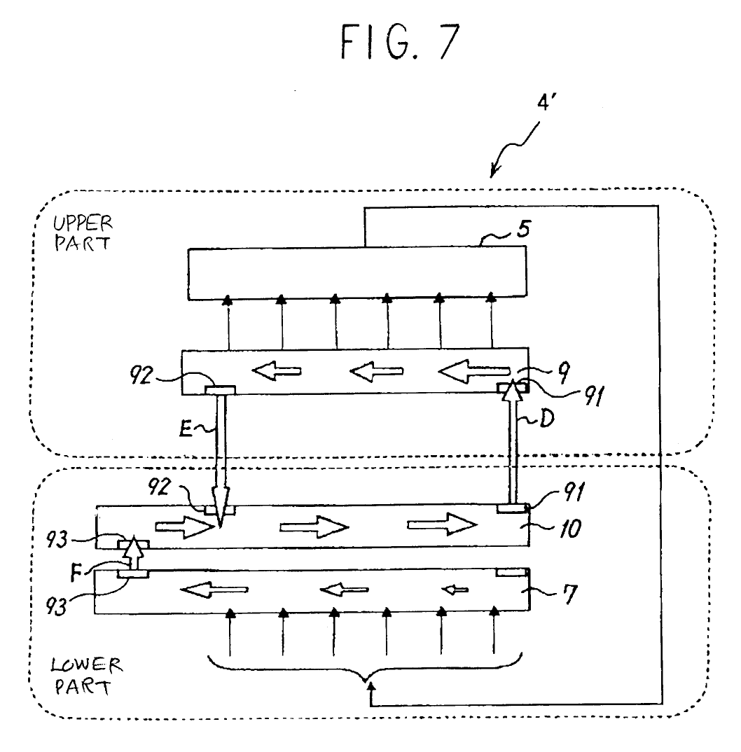

FIG. 7 shows how the developer flows in the developing device 4′.

Note that the arrows shown in each of the drawings indicate the directions of movement of the developer.

In the supply conveyance path 9 to which the developer is supplied from the agitation conveyance path 10, the developer is conveyed to the downstream side in a conveyance direction of the supply screw 8, while being supplied to the developing roller 5. Excess developer that is supplied to the developing roller 5 and conveyed to a downstream end in a conveyance direction of the supply conveyance path 9 without being used for the development is supplied to the agitation conveyance path 10 through an excess opening portion 92 of the first partition wall 133 (arrow E in FIG. 7). The recovery developer that is delivered from the developing roller 5 to the recovery conveyance path 7 and conveyed to a downstream end in a conveyance direction of the recovery conveyance path 7 by the recovery screw 6 is supplied to the agitation conveyance path 10 through a recovery opening portion 93 of the second partition wall 134 (arrow F in FIG. 7). The agitation conveyance path 10 then agitates the supplied excess developer and recovery developer, conveys thus obtained mixture to the upstream side in the conveyance direction of the supply screw 8, which is also the downstream side in a conveyance direction of the agitating screw 11, and supplies it to the supply conveyance path 9 through a supply opening portion 91 of the first partition wall 133 (arrow D in FIG. 7). In the agitation conveyance path 10, the recovery developer, excess developer, and toner replenished from a transporting portion according to need are agitated and conveyed by the agitating screw 11 in the direction opposite to that of the developer of the recovery path 7 and the supply path 9. The agitated developer is transported to the upstream side in the conveyance direction of the supply conveyance path 9 that is communicated at the downstream side in the conveyance direction. Note that the toner density sensor, which is not shown, is provided below the agitation conveyance path 10, and a controller, which is not shown, is actuated by the output of the sensor to control replenishment of the replenishment developer.

In the developing device 4′ having the supply conveyance path 9 and the recovery conveyance path 7, because the developer is supplied and recovered in different developer conveyance paths, the developer used for the development is prevented from being mixed in the supply conveyance path 9. Accordingly, the toner density of the developer supplied to the developing roller 5 is prevented from decreasing as the developer is sent toward the downstream side in the conveyance direction of the supply conveyance path 9. In addition, because the developing device 4′ has the recovery conveyance path 7 and the agitation conveyance path 10 and the developer is recovered and agitated in these different developer conveyance paths, loss of the developer used for the development is prevented during the agitation of the developer. Therefore, since the sufficiently agitated developer is supplied to the supply conveyance path 9, supply of insufficiently agitated developer to the supply conveyance path 9 can be prevented.

As shown in FIG. 7, the developer is moved from the lower part of the developing device 4′ to the upper part of the same in the direction of the arrow D only. The developer is moved in the direction of the arrow D to raise the developer and supply it to the supply conveyance path 9 by pushing the developer as the agitating screw 11 rotates. Such movement of the developer causes stress on the developer, reducing the life of the developer. When the developer is lifted up as described above, stress is placed on the developer; which scrapes a carrier film. Then, spent toner is formed on the stressed part of the developer, and consequently stable image quality can no longer be maintained. Therefore, the life of the developer can be extended by alleviating the stress that is placed on the developer moving in the direction of the arrow D. By extending the life of the developer, it becomes possible to provide a developing device capable of preventing the degradation of the developer and providing stable image quality with no image density irregularity.

In the developing device 4′, the supply conveyance path 9 is disposed obliquely above the agitation conveyance path 10, as shown in FIG. 5. By disposing the supply conveyance path 9 in this manner, the stress placed on the developer moving in the direction of the arrow D can be alleviated more as compared with the case in which the supply conveyance path 9 is provided vertically above the agitation conveyance path 10 to lift up the developer. Furthermore, since the supply conveyance path 9 and the agitation conveyance path 10 are disposed obliquely in the developing device 4′, an upper wall surface of the agitation conveyance path 10 is disposed higher than a lower wall surface of the supply conveyance path 9 as shown in FIG. 5. By lifting up the supply conveyance path 9 vertically above the agitation conveyance path 10, the developer is lifted up by the pressure of the agitating screw 11 against gravitational force, imposing stress on the developer. However, by disposing the upper wall surface of the agitation conveyance path 10 higher than the lower wall surface of the supply conveyance path 9, the developer existing at the uppermost point of the agitation conveyance path 10 can flow into the lowermost point of the supply conveyance path 9 without fighting gravity, and as a result the stress placed on the developer can be reduced. It should be noted that a fin member may be provided on the axis of the agitating screw 11, which is a section through which the agitation conveyance path 10 and the supply conveyance path 9 are communicated with each other at the downstream side of the developer conveyance path of the agitation conveyance path 10. This fin member is a plate-like member configured by a side parallel to the axial direction of the agitating screw 11 and a side perpendicular to the axial direction of the agitating screw 11. By scooping up the developer using this fin member, the developer can be delivered from the agitation conveyance path 10 to the supply conveyance path 9 efficiently.

Moreover, in the developing device 4′ the supply conveyance path 9 and the agitation conveyance path 10 are disposed such that the center distance A between the developing roller 5 and the supply conveyance path 9 is shorter than the center distance B between the developing roller 5 and the agitation conveyance path 10. Therefore, the developer can be supplied from the supply conveyance path 9 to the developing roller 5 naturally, and the size of the device can be reduced. Also, the agitating screw 11 rotates in the counterclockwise direction as viewed from the near side of FIG. 5 (direction of the arrow C in the drawing) so that the developer is lifted up along the shape of the agitating screw 11 and transported to the supply conveyance path 9. Accordingly, the developer can be lifted up efficiently and also the stress placed thereon can be reduced.

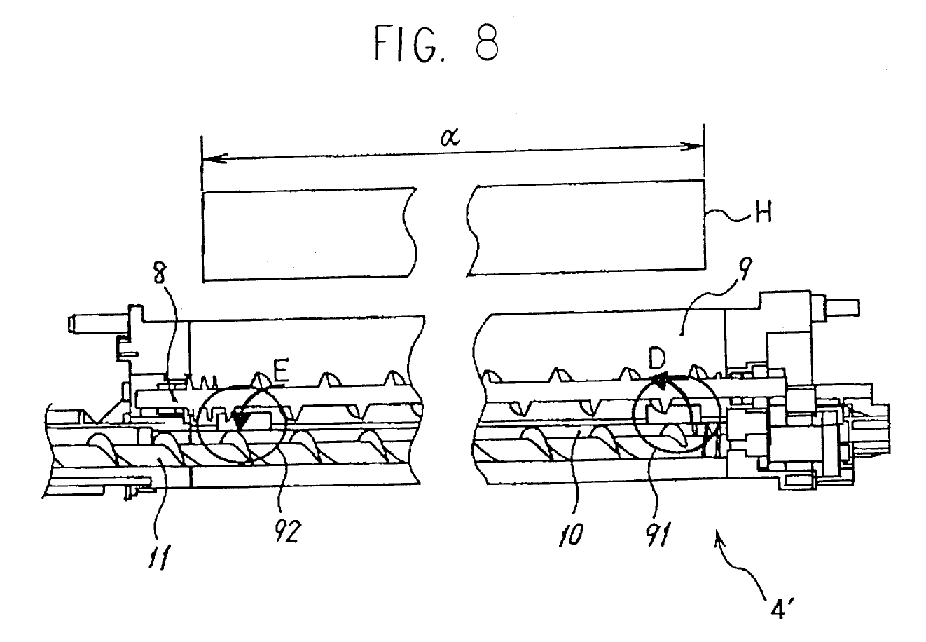

FIG. 8 is a view showing the cross section of the rotation center of the supply screw 8 of the developing device 4′, the cross section being taken along the direction of the arrow J shown in FIG. 6.

Reference numeral H in the drawing shows the developing region in which the developing roller 5 supplies the toner to the photoreceptor 1. The width of the developing region H in the direction of the rotation axis of the developing roller 5 is the developing region width α. As shown in FIG. 8, the developing device 4′ is provided with, within the developing region width α, the supply opening portion 91 for lifting up the developer from the agitation conveyance path 10 to the supply conveyance path 9, and the excess opening portion 92 for dropping the developer from the supply conveyance path 9 to the agitation conveyance path 10.

In order to replace the developer within the developing device, for example, the developer outlet is provided in the abovementioned developing device 4′ to discharge some of the developer contained in the supply conveyance path 9 to the outside of the developing device 4′ when a predetermined bulk is exceeded. Also, a discharge conveyance path for discharging the developer to the outside of the developing device 4′ after the developer is discharged from the developer outlet is further provided. In the developing device 4′, the developer accumulates in the vicinity of the downstream end in the conveyance direction of the supply conveyance path 9, depending on the balance among the amount of developer conveyed to the supply conveyance path 9, the amount of developer supplied to the developing roller 5, and the amount of developer moving from the supply conveyance path 9 to the agitation conveyance path 10 through the excess opening portion 92. When there is a constant amount of developer within the developing device 4′, the amount of developer that reaches the vicinity of the downstream end in the conveyance direction of the supply conveyance path 9 per hour coincides with the amount of developer moving to the agitation conveyance path 10 via the excess opening portion 92 per hour, and the bulk of the accumulated developer is kept constant. However, when the amount of developer within the developing device 4′ increases, the amount of developer that reaches the vicinity of the downstream end in the conveyance direction of the supply conveyance path 9 per hour becomes greater than the amount of developer that moves to the agitation conveyance path 10 via the excess opening portion 92 per hour. Consequently, the bulk of the developer accumulated in the vicinity of the downstream end in the conveyance direction of the supply conveyance path 9 increases. Therefore, the developer outlet is disposed in the position where the developer accumulates in the vicinity of the downstream end in the conveyance direction of the supply conveyance path 9, so that when the bulk of the accumulated developer increases, the developer that reaches the level of the developer outlet can be discharged to the discharge conveyance path.

According to this configuration, once the replenishment developer is replenished by the developer replenishing device 60, the amount of developer within the developing device 4′ increases and, consequently, the bulk of the developer accumulated in the vicinity of the downstream end in the conveyance direction of the supply conveyance path 9 increases. Then, when the bulk of the developer present in the vicinity of the downstream end in the conveyance direction of the supply conveyance path 9 reaches the level of the developer discharging port, the developer that reaches the level of the developer outlet is discharged to the discharge conveyance path 9 and then to the outside of the developing device 4′ via the discharge conveyance path.

Next, a characterizing portion of the present invention, which is the method for producing the developer container 13 filled with the replenishment developer, will be described.

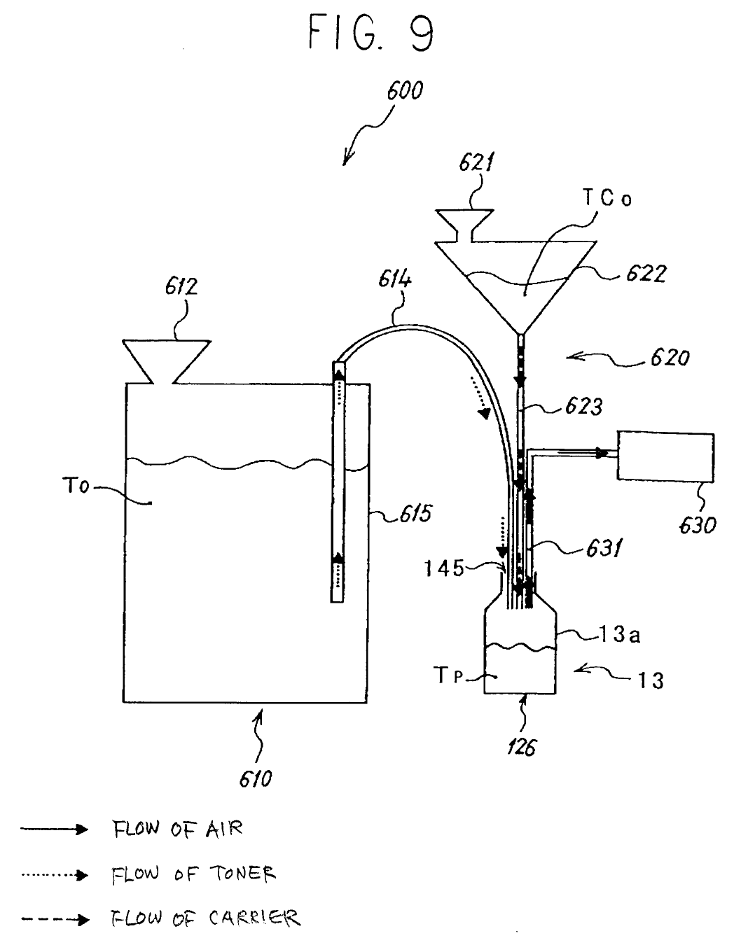

FIG. 9 shows the configuration of a developer filling device 600 which fills up the developer container 13 with a replenishment developer Tp.

As shown in FIG. 9, the developer filling device 600 has a toner filling device 610 for filling the developer container 13 with a replenishing toner T₀ and a pre-mixed developer filling device 620 for filling the developer container 13 with a pre-mixed developer TC₀. The developer filling device 600 further has a deaeration device 630 for deflating the developer container 13 filled with the replenishment toner T₀ and pre-mixed developer TC₀.

Also, when filling the developer container 13 with the replenishment toner T₀ and pre-mixed developer TC₀, the developer container 13 is placed, with an opening portion 13f of the pouch portion 13a facing upward, the opening portion 13f having the mouthpiece member 13b of the developer container 13 attached thereto, as shown in FIG. 9, and the replenishment toner T₀ and pre-mixed developer TC₀ are filled into the opening portion 13f. Note that the mouthpiece member 13b is not attached to the opening portion 13f in this filling step.

The toner filling device 610 has a toner accumulating portion 615 for accumulating the toner T₀ supplied from a toner supply port 612. A toner filling nozzle 614, which conveys the replenishment toner T₀ accumulated in the toner accumulating portion 615 by using the suction power of the powder pump (not shown), is connected to the toner accumulating portion 615. The end portion of the toner filling nozzle 614 that is not connected to the toner accumulating portion 615 is inserted into the opening portion 13f of the developer container 13 to drive the powder pump (not shown), and thereby the developer container 13 can be filled with the replenishment toner T₀. The amount of replenishment toner T₀ be filled in is adjusted according to the time during which the powder pump (not shown) is driven.

On the other hand, the pre-mixed developer filling device 620 has a pre-mixed developer accumulating portion 622 for accumulating the pre-mixed developer TC₀ supplied from a pre-mixed developer supply port 621. A pre-mixed developer filling nozzle 623 is connected to the lowermost portion of the pre-mixed developer accumulating portion 622, and the connected portion between the pre-mixed developer accumulating portion 622 and the pre-mixed developer filling nozzle 623 is provided with an on-off valve, which is not shown. The end portion of the pre-mixed developer filling nozzle 623 that is not connected to the pre-mixed developer accumulating portion 622 is inserted into the opening portion 13f of the developer container 13 to open the on-off valve (not shown), and thereby the developer container 13 can be filled with the pre-mixed developer TC₀. The gravitational force moves the pre-mixed developer TC₀ from the pre-mixed developer accumulating portion 622 to the developer container 13, and the amount of pre-mixed developer TC₀ to be filled in is adjusted according to the time during which the on-off valve (not shown) is opened.

An end of a deaeration nozzle 631 is connected to the deaeration device 630, while the other end is inserted into the opening portion 13f of the developer container 13 to drive the deaeration device 630, whereby the developer container 13 can be deflated.

By filling the developer container 13 with the replenishment toner T₀ and pre-mixed developer TC₀ as described above, the developer container 13 becomes filled with the replenishment developer Tp consisting of the replenishment toner T₀ and the pre-mixed developer TC₀. As a result, the developer container 13 becomes the developer container filled with developer.

Incidentally, since the developer container 13 of Embodiment 1 is not provided with any agitating member for agitating the replenishment developer contained in the developer container 13, the replenishment developer Tp that fills up the developer container filled with developer 13 cannot be agitated. Therefore, when discharging the replenishment developer Tp from the mouthpiece member 13b, there is risk of discharging the pre-mixed developer TC₀ only, depending on the method for filling the developer container 13 with the replenishment toner T₀ and pre-mixed developer TC₀ using the developer filling device 600. Therefore, in Embodiment 1, the target toner density of the developer contained in the developing device is set at 7 [wt %] (meaning that the carrier weight ratio is 93 [wt %]). In the case where the carrier weight ratio of the pre-mixed developer TC₀ is higher than 93 [wt %], the toner density of the developer contained in the developing device might not be able to approach the abovementioned target toner density even when only this pre-mixed developer TC₀ is replenished into the developing device. In other words, in the case where the toner density of the developer contained in the developing device is higher than the toner density of the pre-mixed developer TC₀ before the replenishment developer is replenished into the developing device, the toner density of the developer decreases even after the replenishment is performed, which means that the toner density of the developer cannot approach the target toner density before the replenishment developer is replenished into the developing device.

In the case where the developer container 13 is not provided with any agitating member, the user can shake and then set the developer container filled with developer 13 when setting up this developer container 13 on the set portion 63 so that the developer within this developer container 13 can be agitated and the pre-mixed developer TC₀ is prevented from being discharged alone. However, in order to allow the user to sufficiently agitate the developer within the developer container simply by shaking the developer container 13, the percentage of void within the developer container 13 (the proportion of the air within the developer container 13) needs to be approximately 50%. The percentage of void within the developer container 13 is normally set to as low as approximately 10% low in order to secure the filling amount of the replenishment developer. Specifically, setting the percentage of void to approximately 50% is not realistic because it leads to a significant reduction of the filling amount of the replenishment developer. Moreover, it cannot guarantee that the user always shakes and then sets up the developer container 13.

Therefore, in Embodiment 1, the pre-mixed developer TC₀ that is put into the developer container 13 along with the replenishment toner T₀ as the replenishment developer is prepared such that the carrier weight ratio of the pre-mixed developer TC₀ is lower than the carrier weight ratio of the target toner density of the developing device (93 [wt %]) (i.e., the toner density is higher than the target toner density). In this manner, even in the case where only the pre-mixed developer TC₀ is replenished into the developing device, the toner density of the developer to be replenished can be certainly brought close to the target toner density so that the toner density can be recovered.

Next, the results of experiments performed by the six inventors will be described.

In these experiments, a test machine having the same configuration as the above-described copying machine of Embodiment 1 was used to form a total of 3000 images by repeatedly forming five evaluation images with a high image area ratio of 20% at one time. Then, a replenishing operation was performed under the highest replenishment capacity by using three replenishment developers having different carrier weight ratios, to measure a detected-pattern adhesion amount and a toner density TC of a developer within the developing device. Note that the detected-pattern adhesion amount is obtained by detecting the density of a patch (detection pattern) formed between images on the surface of the image carrier by means of an optical sensor, and then converting the detected patch density to a toner adhesion amount [mg/cm²], the patch being obtained by developing a measurement latent image. All of the replenishment developers are agitated sufficiently so that the toner and carrier of each of the replenishment developers are uniformly dispersed.

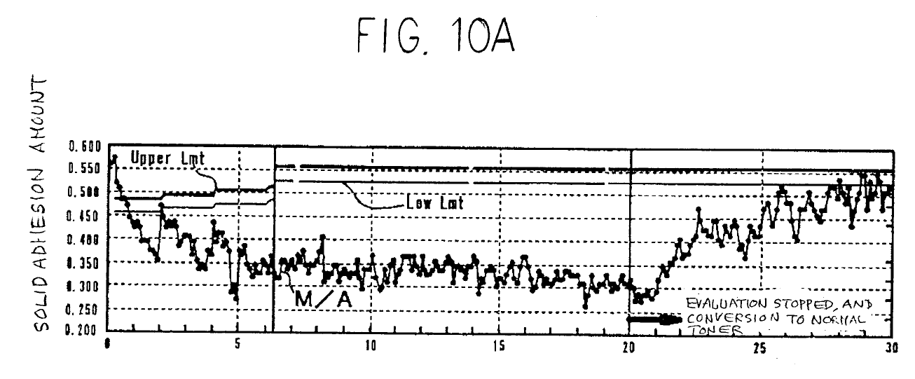

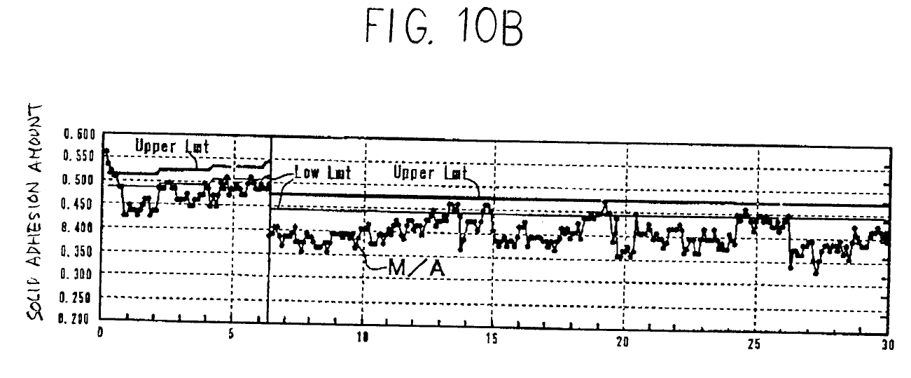

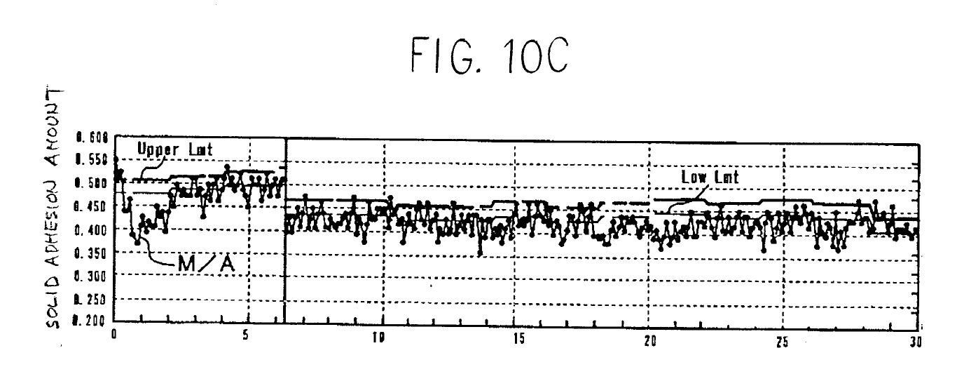

FIGS. 10A to 10C are each a graph showing the results of the experiments performed for obtaining the detected-pattern adhesion amount. Note that FIG. 10A shows the result of an experiment performed using the replenishment developer having a carrier weight ratio of 90 [wt %], FIG. 10B the result of an experiment performed using the replenishment developer having a carrier weight ratio of 70 [wt %], and FIG. 10C the result of an experiment performed using the replenishment developer having a carrier weight ratio of 50 [wt %].

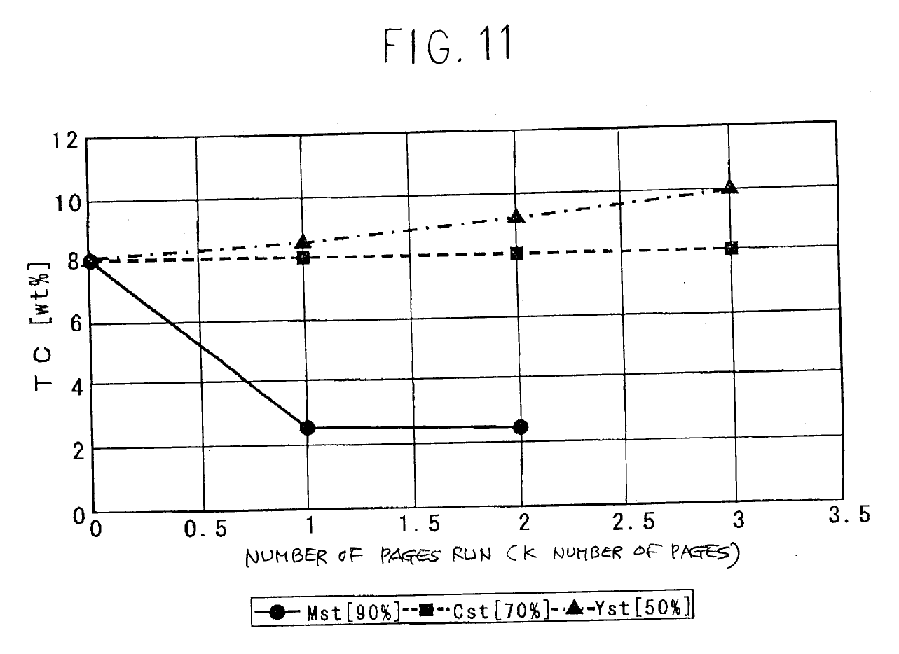

FIG. 11 is a graph showing the result of an experiment performed for obtaining the toner density TC.

As shown in the graph of FIG. 10A, when the replenishment developer with a carrier weight ratio of 90 [wt %] is used, toner replenishment cannot be performed subsequently to the continuous formation of images having a high image ratio of 20%. This is because the toner cannot be replenished sufficiently by the amount consumed in development, due to a low amount of toner that is replenished per hour. However, as shown in FIGS. 10B and 10C, when the replenishment developers with carrier weight ratios of 70 [wt %] and 50 [wt %] are used, toner replenishment can be barely performed subsequently to the continuous formation of images having a high image ratio of 20%. This is because the toner can be replenished by the amount consumed in development, due to a relatively large amount of toner that is replenished per hour. These facts can be understood from the graph shown in FIG. 11.

As is clear from the above experimental results, the decrease in the image density and accordingly the decrease in the image quality are sometimes caused when replenishing the replenishment developers with high carrier weight ratios (replenishment developers with low toner densities). Moreover, even in the case where the replenishment developer with high carrier weight ratio is replenished locally, the image density corresponding to this part is reduced. As a result, in order not to cause a local insufficiency of image density even under the rigid conditions where images with a high image area ratio of 20% are continuously formed using this test machine, it is important to perform replenishment such that the carrier weight ratio of the replenishment developer to be replenished into the developing device does not exceed 70 [wt %].

Although the upper limit of the carrier weight ratio of the replenishment developer that does not cause such an image density insufficiency is 70 [wt %] in the present test machine, it is considered that this upper limit changes to a certain extent, depending on the configuration and settings of the copying machine. However, at any rate, in the case where the carrier weight ratio of the replenishment developer to be replenished into the developing device exceeds the upper limit even temporarily, a local insufficiency of image density occurs at the image portion corresponding to this part where the carrier weight ratio of the replenishment developer is increased. Therefore, in order to prevent the occurrence of the local insufficiency of image density, it is important that the carrier weight ratio of the replenishment developer to be replenished into the developing device do not exceed the upper limit at all times.

For this reason, in Embodiment 1 the carrier weight ratio of the pre-mixed developer TC₀ is set at a value that is further lower than the carrier weight ratio (93 [wt]) of the target toner density of the developing device, or in other words a value that is equal to or lower than the upper limit (70 [wt %]) of the carrier weight ratio of the replenishment developer that does not cause an image density insufficiency. Consequently, even in the case where only the pre-mixed developer TC₀ is replenished to the developing device under the rigid conditions where images with high image area ratio are formed continuously, the occurrence of a local insufficiency of image density can be inhibited stably. Therefore, according to Embodiment 1, the occurrence of a local insufficiency of image density can be inhibited stably by any method for filling the developer container 13 with the pre-mixed developer TC₀ and replenishment toner T₀.

Next will be described another embodiment (Embodiment 2) of the copying machine serving as the image forming apparatus to which the present invention is applied. Note that the copying machine according to Embodiment 2 is the same as that of Embodiment 1 aside from the fact that the configurations of a developer container and developer replenishing device used in Embodiment 2 are different, hence the components associated with the developer container and developer replenishing device of Embodiment 2 will be described and the rest of the configurations will be omitted hereinafter.

### Embodiment 2

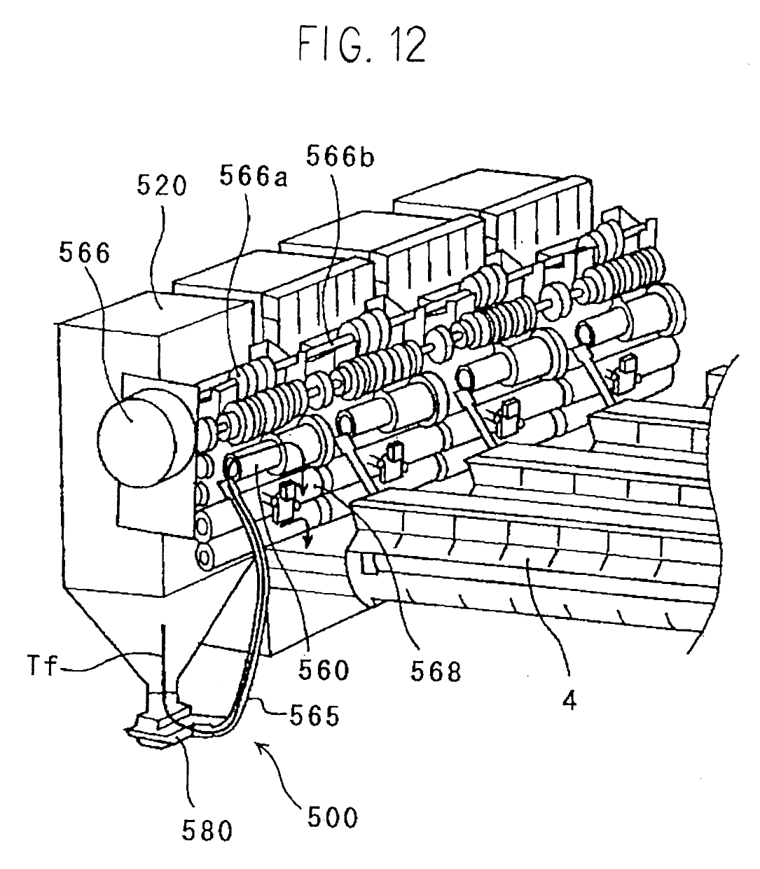

FIG. 12 shows the configuration of a developer replenishing device 500 provided in the copying machine of Embodiment 2.

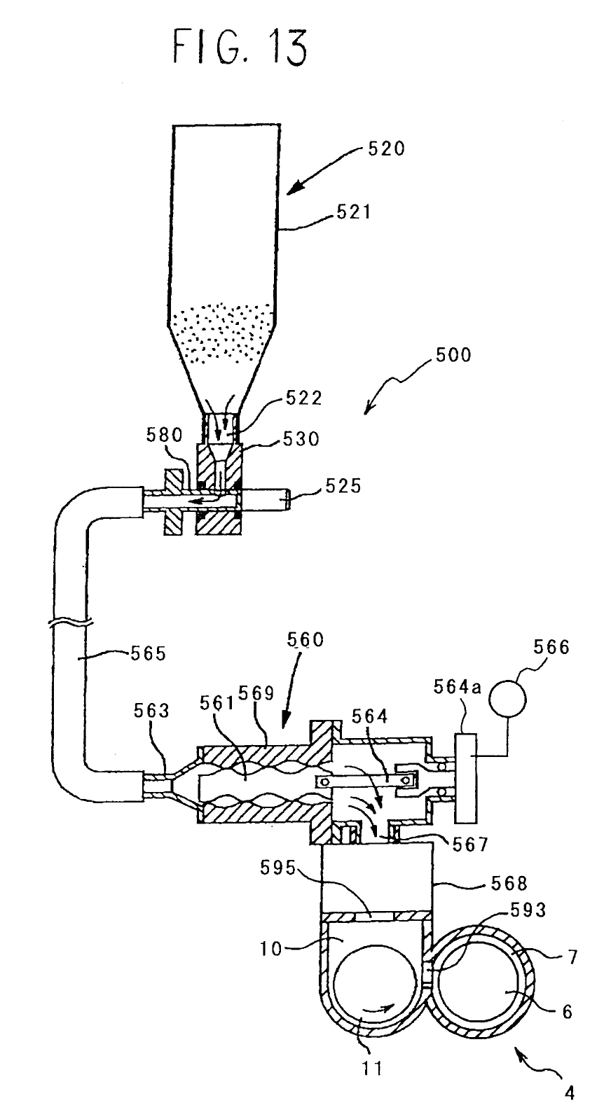

FIG. 13 shows a schematic configuration of the developer replenishing device 500.

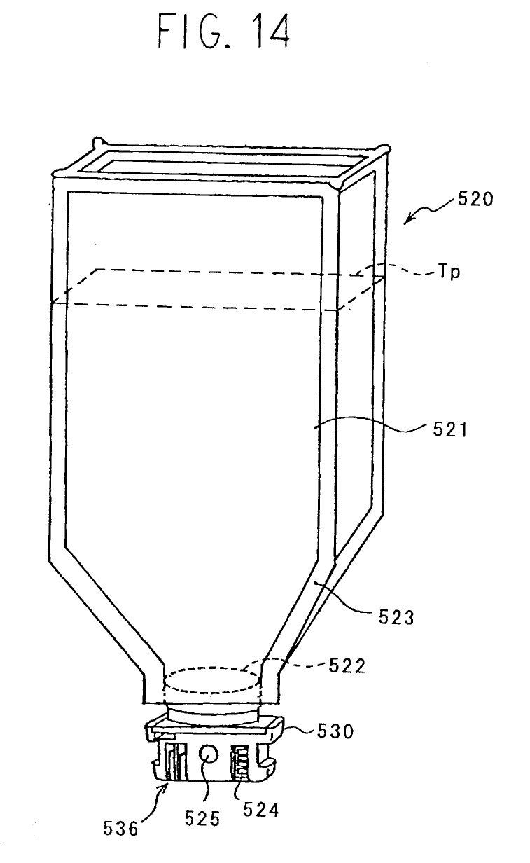

FIG. 14 shows an external perspective view of a developer container 520.

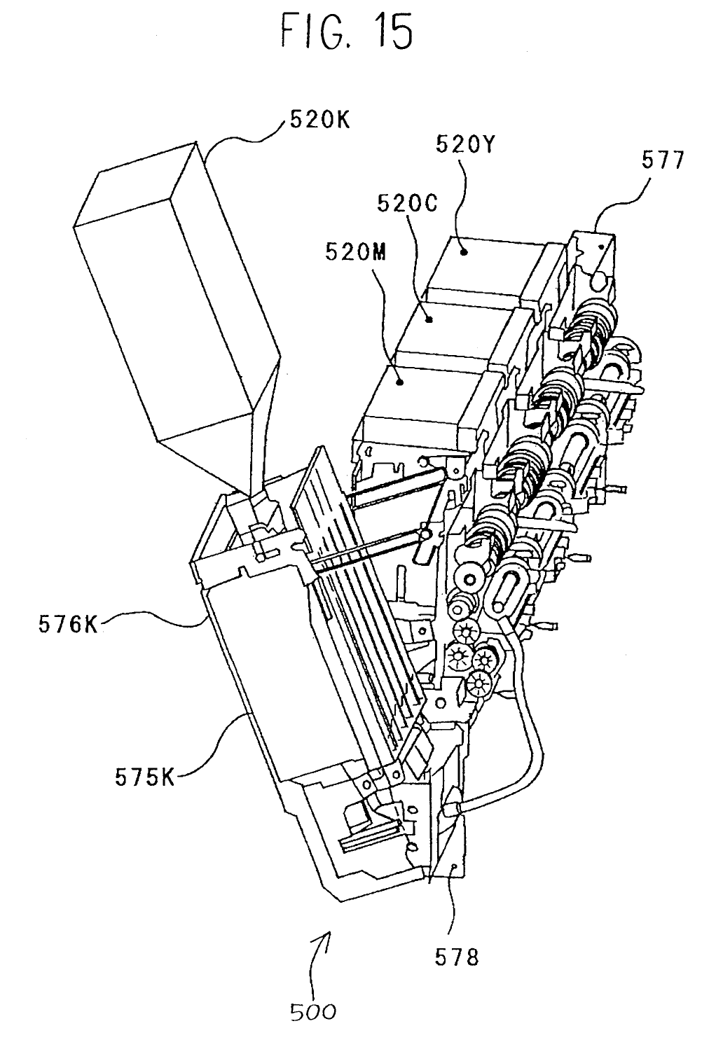

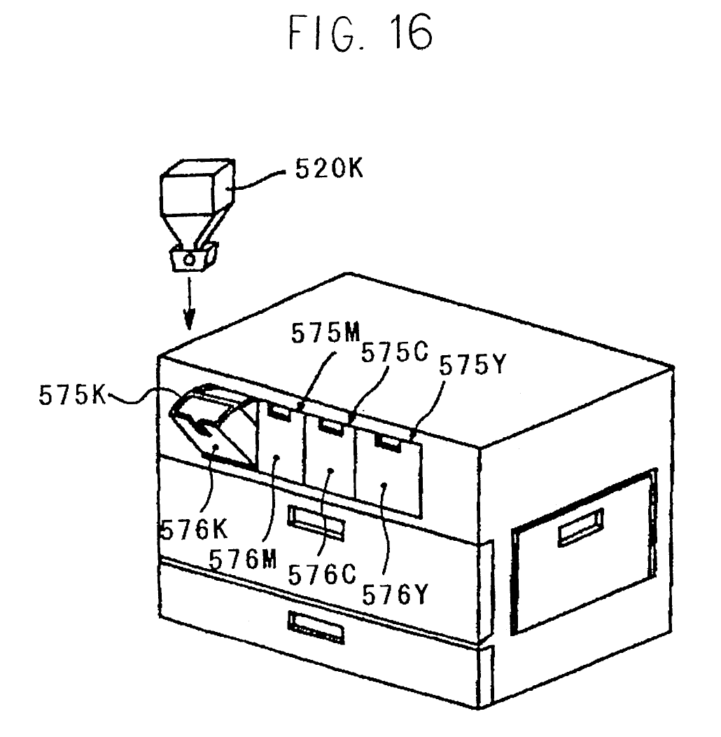

FIG. 15 shows how a developer container 520 for the color K is set up, and FIG. 16 shows the appearance of the copying machine to explain how the developer container 520 for the color K is set up.

The copying machine according to Embodiment 2, which is a tandem-type image forming apparatus, is configured such that the developer containers 520 containing respective colors of replenishment developers are arranged therein as shown in FIG. 12, FIG. 15 and FIG. 16. Each of the developer containers 520 is connected to a replenishing unit having a sub-hopper 568 and a powder pump 560 by a transport tube 565, and the developing device 4 is connected to a lower part of the replenishing unit.

The developer containers 520 are filled with replenishment developers by the same method as the one described in Embodiment 1. As shown in FIG. 13 and FIG. 14, each of the developer containers 520 is configured by a pouch portion 521 functioning as the developer container, and a mouthpiece member 530 functioning as the developer outlet attached to a toner outlet 522 functioning as one and only powder outlet. Note that the reference numeral Tf shown in FIG. 12 represents the flow of the replenishment developer. The developer replenishing device 500 is provided with four container supporting holders 575Y, 575M, 575C and 575K that are openable by rotating about respective rotation axes (not shown), as shown in FIG. 15 and FIG. 16. Outside surfaces 576Y, 576M, 576C and 576K of the respective container supporting holders are exposed from the front surface of the device main body, as shown in FIG. 16. These container supporting holders 575Y, 575M, 575C and 575K contain and support the developer containers 520 with the respective colors, respectively. When setting up, for example, the K developer container 520K in the container supporting holder 575K, an operator releases a lock, which is not shown, to open the container supporting holder 575K by turning it toward the near side, as shown in the diagram. The operator then grasps the developer container 520K with his/her hand with the mouthpiece member 530 facing downward in the vertical direction, and inserts the developer container 520K into the container supporting holder 575K such as to drop it.

In a state in which each of the developer containers 520 is set up in the respective container supporting holder 575, a leading end of a nozzle 580 that is coupled to the mouthpiece member 530 as a coupling member provided in the device main body is inserted into the each developer container 520. Consequently, the toner outlet 522 and a toner receiving port of the nozzle 580 are brought into communication with each other. The nozzle 580 has a joint shape portion for connecting the tube, and the transport tube 565 is communicated with the powder pump 560. Moreover, the powder pump 560 is communicated with the developing device 4 by the sub-hopper 568. By setting up the developer container 520 in the respective container supporting holder 575 in this manner, the developing device 4 and the replenishing unit are communicated with each other.

The powder pump 560 uses a mohno-pump called an ejection-type uniaxial eccentric screw pump, which has a stator 569 having spiral grooves on its cylindrical inner wall surface and made of an elastic member, and a rotor 561 that moves the replenishment developer in the axial direction by rotating within the stator 569, as shown in FIG. 13. The rotor 561 is shaped such that its axial member having a hard circular cross section is twisted spirally, and is coupled to a drive motor 566 by a drive transmitting portion and universal joint 564. The stator 569, made of a rubber or other flexible material, has an elongated hole whose cross section is twisted spirally. The spiral pitch of the stator 569 is twice as long as the spiral pitch of the rotor 561. The replenishment developer can be transported through a space that is formed between the rotor 561 and stator 569 by engaging these two parts together and rotating the rotor 561. Specifically, the powder pump 560 generates negative pressure in a suction port 563 by rotating the rotor 561, which is one member from among the rotor 561 and stator 569, and causing it to slide against the stator 569, which is the other member from among the rotor 561 and stator 569. Due to the negative pressure generated in the suction port 563, an air current is generated within the transport tube 565. In the powder pump 560 that is configured as described above, when the rotor 561 is driven to rotate, the replenishment developer of the developer container 520 enters the powder pump 560 from the suction port 563. The replenishment developer is then suctioned and conveyed from the left to the right in FIG. 13 and supplied from an ejection port 567 to the sub-hopper 568 and then from a toner replenishing port 595 disposed in a lower part of the developing device 4 to the inside of the developing device 4. Note that the one described in Japanese Unexamined Patent Application Publication No. 2000-98721 can be used as the powder pump 560.

The same experiments as those of Embodiment 1 are performed with a test machine having the same configuration as the copying machine of Embodiment 2.

Next will be described a modification of the method for producing the developer containers 13, 520. Note that the modification is described hereinafter using the developer container 13 of Embodiment 1.

### Modification

The developer container 13 is massively produced as it is a disposable product, and therefore low production cost and high productivity need to be achieved. Because the pre-mixed developer TC₀ used in the above-described production method of Embodiment 1 has a carrier weight ratio of 70 [wt %] or lower, it is necessary to prepare the pre-mixed developer TC₀ independently from the initial developer having a carrier weight ratio of 93 [wt %]. As described above, since it is extremely difficult to agitate a large amount of toner and carrier until they are dispersed to some extent, preparation of the two types of developers, i.e., the initial developer and pre-mixed developer TC₀, inflates the production cost. Therefore, this modification explains a method for producing the developer container 13, which is, as with the one described in Embodiment 1, capable of stably inhibiting the occurrence of a local insufficiency of image density, while using the pre-mixed developer TC₀ and initial developer as-is.

The production method of the present modification uses the developer filling device 600 shown in FIG. 9 to fill the developer container 13 so that the pre-mixed developer TC₀ does not exist alone in the vicinity of the mouthpiece member 13b provided inside the pouch portion 13a filled with the pre-mixed developer TC₀ and replenishment toner T₀, and consequently to produce the developer container filled with developer. Specifically, after the toner filling device 610 starts pouring the replenishment toner T₀, the pre-mixed developer filling device 620 starts pouring the pre-mixed developer TC₀. The pre-mixed developer filling device 620 may start pouring the pre-mixed developer TC₀ upon completion of pouring the replenishment toner T₀, any time after the toner filling device 610 starts pouring the replenishment toner T₀. In Embodiment 1, the pre-mixed developer filling device 620 starts pouring the pre-mixed developer TC₀ once the toner filling device 610 finishes pouring the replenishment toner T₀.

According to the production method of the present modification, the pre-mixed developer TC₀ does not exist alone in the vicinity of the mouthpiece member 13b inside the developer container filled with developer 13.

Therefore, the pre-mixed developer TC₀ alone is discharged from the developer container 13 without being mixed with the replenishment toner T₀ and thus is prevented from being supplied to the developing device. More specifically, in the case where the pre-mixed developer TC₀ supposedly exists alone in the vicinity of the mouthpiece member 13b inside the pouch portion 13a, only the pre-mixed developer TC₀ is discharged when the replenishment developer Tp is discharged from the developer container 13 for the first time. However, in the case where the pre-mixed developer TC₀ alone does not exist in the vicinity of the mouthpiece member 13b inside the pouch portion 13a, the pre-mixed developer TC₀ is no longer discharged when the replenishment developer Tp is discharged from the developer container 13 for the first time. The replenishment developer Tp contained in the developer container gradually moves toward the mouthpiece member 13b as the replenishment developer Tp is discharged from the developer container 13 in this manner, and at this moment the pre-mixed developer TC₀ can be mixed with the replenishment toner T₀. Therefore, even in the case where the developer container is filled with the replenishment developer so that the pre-mixed developer TC₀ and the replenishment toner T₀ are completely isolated from each other as in the present modification, the pre-mixed developer TC₀ is prevented from being discharged alone. Therefore, according to the production method of the present modification, the initial developer with a high carrier weight ratio of 93 [wt %] can be used as the pre-mixed developer TC₀ as-is, and a mixture of the pre-mixed developer TC₀ and the replenishment toner T₀ can be supplied to the developing device, while keeping the production cost low, whereby the occurrence of a local insufficiency of image density can be prevented.

According to Embodiments 1 and 2 described above, there is provided the pouch portion 13a, 521 functioning as the developer containing body for containing the replenishment developer Tp consisting of a toner and a carrier, and the mouthpiece member 13b, 530 functioning as the developer outlet for discharging the replenishment developer Tp from the inside of the pouch portion 13a, 521 to the outside, wherein when producing the developer container filled with developer 13, 520, which is mounted on the developer replenishing device 60, 500 that conveys the replenishment developer Tp discharged from the mouthpiece member 13b, 530 to the developing device 4, 4′, the pre-mixed developer TC₀ that has lower carrier weight ratio than the initial developer having a mixture of the toner and carrier and filled in the early stages into the developing device 4, 4′ is produced, and the pouch portion 13a, 521 is filled with this pre-mixed developer TC₀ and the single toner T₀ separately, whereby the developer container filled with developer 13, 520 is produced. As a result, it is possible to produce the developer container filled with developer 13, 520 that is capable of stably inhibiting the occurrence of a local insufficiency of image density, regardless of how the pre-mixed developer TC₀ and replenishment toner T₀ are poured.

However, in the case where the developer container filled with developer 13, 520 produced by the above method is used under the rigid conditions where images with high image area ratio are formed continuously, there is a possibility for the local insufficiency of image density to occur. Therefore, when filling the pouch portion 13a, 521 with the pre-mixed developer TC₀ and toner T₀, the pouch portion 13a, 521 may be filled with the pre-mixed developer TC₀ and the single toner T₀ separately so that the pre-mixed developer TC₀ does not exist alone in the vicinity of the mouthpiece member 13b, 530 inside the pouch portion 13a, 521. With the developer container filled with developer 13, 520 produced by the above method, the mixture of the pre-mixed developer TC₀ and the toner T₀ can be supplied to the developing device 4, 4′, and the pre-mixed developer TC₀ can be prevented from being supplied alone to the developing device 4, 4′. Consequently, it is possible to produce the developer container filled with developer 13, 520 capable of preventing the occurrence of the local insufficiency of image density even under the rigid conditions where images with high image area ratio are formed continuously.

In addition, according to the above modification, the developer container filled with developer 13, 520 is produced by filling the pouch portions 13a, 521 with the pre-mixed developer TC₀ comprising the initial developer to be filled to the developing device 4, 4′ in an early stage and with the single toner T₀ separately so that the pre-mixed developer TC₀ does not exist alone in the vicinity of the mouthpiece member 13b, 530 inside the filled pouch portion 13a, 521. Therefore, since it is unnecessary to prepare new pre-mixed developer TC₀ independently from the initial developer, the production cost can be reduced. Moreover, by using the developer container filled with developer 13, 520 produced by this method, the mixture of the pre-mixed developer TC₀ and toner T₀ can be supplied to the developing device 4, 4′ and thereby the pre-mixed developer TC₀ can be prevented from being supplied alone to the developing device 4, 4′. Consequently, it is possible to produce the developer container filled with developer 13, 520 capable of preventing the occurrence of the local insufficiency of image density even under the rigid conditions where images with high image area ratio are formed continuously.

As a specific method for filling the pouch portion 13a, 521 with the pre-mixed developer TC₀ and the single toner T₀ separately so that the pre-mixed developer TC₀ does not exist alone in the vicinity of the mouthpiece member 13b, 530 inside the filled pouch portion 13a, 521, it is possible to adopt a method for filling the pouch portion 13a, 521 with the pre-mixed developer TC₀ from the mouthpiece member 13b, 530, after filling pouch portion 13a, 521 with the single toner T₀ from the mouthpiece member 13b, 530. The productivity can be further improved with this method.

Moreover, as the developer container filled with developer 13, 520, according to Embodiment 1 and 2, which has the pouch portion 13a, 521 for containing the replenishment developer Tp consisting of a toner and a carrier and the mouthpiece member 13b, 530 for discharging the replenishment developer Tp from the inside the pouch portion 13a to the outside, and which is mounted on the developer replenishing device that conveys the replenishment developer Tp discharged from the mouthpiece member 13b, 530 to the developing device 4, 4′, it is possible to use the developer container filled with developer 13, 520 in which the pouch portion 13a, 521 is filled with the pre-mixed developer TC₀ and the single toner T₀, the pre-mixed developer TC₀ having lower carrier weight ratio than the initial developer filled into the developing device 4, 4′ in the early stages as a mixture of the toner and carrier, so that the occurrence of the local insufficiency of image density can be inhibited stably. Particularly, as long as the pouch portion 13a, 521 is filled with the pre-mixed developer TC₀ and the single toner T₀ so that the pre-mixed developer TC₀ does not exist alone in the vicinity of the mouthpiece member 13b, 530 inside the pouch portion 13a, 521, the occurrence of the local insufficiency of image density can be prevented even under the rigid conditions where images with high image area ratio are formed continuously.

In addition, as the developer container filled with developer 13, 520, which has the pouch portion 13a, 521 for containing the replenishment developer Tp consisting of a toner and a carrier and the mouthpiece member 13b, 530 for discharging the replenishment developer Tp from the inside the pouch portion 13a, 521 to the outside, and which is mounted on the developer replenishing device that conveys the replenishment developer Tp discharged from the mouthpiece member 13b, 530 to the developing device 4, 4′, it is possible to use the developer container 13, 520 filled with developer 13, 520 in which the pouch portion 13a, 521 is filled with the pre-mixed developer TC₀ filled in the early stages into the developing device 4, 4′ and the single toner T₀ so that the pre-mixed developer TC₀ does not exist alone in the vicinity of the mouthpiece member 13b, 530 inside the pouch portion 13a, 521, whereby the occurrence of the local insufficiency of image density can be inhibited stably at low cost even under the rigid conditions where images with high image area ratio are formed continuously.

Particularly, as long as the pouch portions 13a, 521 of the developer containers 13 and 520 are configured such that the volumes thereof are reduced as the replenishment developer Tp is discharged to the outside via the mouthpiece members 13b and 530, it is possible to achieve many beneficial effects including their excellent handling performance when carrying or storing used developer containers, because they do not take up much space, unlike those hard bottles such as the conventional cartridges and bottles. Such a configuration can be realized easily by, for example, providing at least part of the pouch portion 13a, 521 with a flexible section and making the flexible section deform and the volume of the pouch portion 13a, 521 decrease as the replenishment developer Tp is discharged to the outside via the mouthpiece member 13b, 530.

According to the method for producing the developer container filled with developer of the present invention described above, the pre-mixed developer produced by mixing a toner and a carrier and the single toner are separately filled into the developer container. In so doing, the replenishment developer contained in the developer container can have an aimed carrier weight ratio (toner density) by filling the pre-mixed developer and the single toner into the developer container. Therefore, in the present production method the carrier weight ratio of the pre-mixed developer can be set higher than the aimed carrier weight ratio of the replenishment developer contained in the developer container. Generally, the higher the carrier weight ratio of the developer in which the carrier and toner need to be dispersed uniformly, the easier it is to achieve the uniform dispersion. Therefore, according to the present invention, compared to the case where the pre-mixed developer is prepared to have the aimed carrier weight ratio and then the developer container is filled only with this pre-mixed developer, it is easier to prepare the pre-mixed developer in which the carrier and toner are uniformly dispersed. As a result, compared to the case where the developer container is filled only with the pre-mixed developer, a replenishment developer having a carrier only is prevented from being replenished into the developing device, the replenishment developer causing a local reduction of image density.

Furthermore, according to the method for producing the developer container filled with developer of the present invention, since the pre-mixed developer and the single toner are filled separately into the developer container, the replenishment developer that is contained in the developer container produced by the present production method is not dispersed uniformly as a whole. Therefore, when replenishing the replenishment developer using this developer container, there is a risk that the pre-mixed developer is replenished alone into the developing device. The carrier weight ratio of the pre-mixed developer used in the present production method is lower than the carrier weight ratio of the initial developer that fills the developing device in the early stages. Because the toner density (toner weight ratio) of the initial developer is set at the target toner density of the developing device, the toner density of the pre-mixed developer is set higher than the target toner density of the developing device to which the pre-mixed developer is replenished. Therefore, even in the case where only the pre-mixed developer is replenished to the developing device without being mixed with the single toner, the toner density of the developer contained in the developing device can be securely recovered close to the target toner density. Consequently, in the image forming apparatus that performs replenishment using the developer container produced by the present production method, the local reduction of image density can be inhibited.

According to the method for producing the developer container filled with developer of the present invention, the pre-mixed developer that fills the developer container along with the single toner consists of the initial developer that initially fills the developing device to which this pre-mixed developer is replenished.

Therefore, the initial developer can be used directly as the pre-mixed developer that fills the developer container, and consequently cost reduction can be achieved.

Since the present production method fills the developer container with the pre-mixed developer and the single toner separately, the replenishment developer contained in the developer contained produced by the present production method is not uniformly dispersed as a whole. Moreover, since the pre-mixed developer is the initial developer, if only the pre-mixed developer is replenished to the developing device, then the toner density of the developer contained in the developing device cannot be recovered to the target toner density; which can cause the local reduction of image density. Therefore, the present production method fills the developer container with the pre-mixed developer and the single toner so that the pre-mixed developer does not exist alone in the vicinity of the developer outlet inside the developer container after it is filled with the pre-mixed developer and the single toner. As a result, the pre-mixed developer is prevented from being replenished alone to the developing device without being mixed with the single toner when the replenishment developer is discharge from the developer container for the first time. Specifically, in the case where only the pre-mixed toner exists in the vicinity of the developer outlet inside the developer container, the pre-mixed developer is discharged alone when the replenishment developer is discharged from the developer container for the first time. When, conversely, the pre-mixed developer does not exist alone in the vicinity of the developer outlet inside the developer container, the pre-mixed developer is no longer discharged alone when the replenishment developer is discharged from the developer container for the first time. Then, although the replenishment developer within the developer container gradually moves toward the developer outlet as the replenishment developer Tp is discharged from the developer container 13 as described above, the pre-mixed developer can be mixed with the single toner during this movement. As a result, even when the replenishment developer is filled into the developer container so that the pre-mixed developer and the single toner are completely isolated from each other, the pre-mixed developer is not discharged alone as long as the pre-mixed developer does not exist alone in the vicinity of the developer outlet inside the developer container. Therefore, the developer container produced by the present production method can securely recover the toner density of the developer of the developing device close to the target toner density. Consequently, in the image forming apparatus that performs replenishment using this developer container, the local reduction of image density can be inhibited.

Because the present invention can stably prevent the occurrence of a local reduction of image density even when the entire replenishment developer is not dispersed uniformly, it is possible to achieve the excellent effect of stably preventing the occurrence of the local reduction of image density while reining the production cost.

Various modifications will become possible for those skilled in the art after receiving the teachings of the present disclosure, without departing from the scope thereof.

What is claimed is:

1. A method for producing a developer container filled with developer, the container having a developer containing body for containing a replenishment developer comprising a toner and a carrier, and a developer discharge outlet for discharging the replenishment developer from the inside to the outside of the developer containing body, and the container being mounted on a developer replenishing device that conveys the replenishment developer discharged from the developer discharge outlet to a developing device,
the method comprising the steps of:
producing a pre-mixed developer that has a carrier weight ratio lower than that of an initial developer having a mixture of a toner and a carrier and filled into the developing device in an early stage; and
filling the developer containing body with the pre-mixed developer and the single toner separately.

2. The method for producing the developer container filled with developer as claimed in claim 1, wherein, when filling the developer containing body with the pre-mixed developer and the single toner, the developer containing body is filled with the pre-mixed developer and the single toner separately so that the pre-mixed developer does not exist alone in the vicinity of the developer discharge outlet inside the filled developer containing body.

3. The method for producing the developer container filled with developer as claimed in claim 2, wherein the pre-mixed developer is filled into the developer containing body from the developer discharge outlet after the single toner is filled into the developer containing body from the developer discharge outlet.

4. A method for producing a developer container filled with developer, the container having a developer containing body for containing a replenishment developer comprising a toner and a carrier, and a developer discharge outlet for discharging the replenishment developer from the inside to the outside of the developer containing body, and the container being mounted on a developer replenishing device that conveys the replenishment developer discharged from the developer discharge outlet to a developing device,
the method comprising the step of filling the developer containing body with a pre-mixed developer comprising an initial developer that is filled into the developing device in an early stage and with the single toner separately so that the pre-mixed developer does not exist alone in the vicinity of the developer discharge outlet inside the filled developer containing body, the pre-mixed developer.

5. The method for producing the developer container filled with developer as claimed in claim 4, wherein the pre-mixed developer is filled into the developer containing body from the developer discharge outlet after the single toner is filled into the developer containing body from the developer discharge outlet.

6. A developer container filled with developer, the container having a developer containing body for containing a replenishment developer comprising a toner and a carrier, and a developer discharge outlet for discharging the replenishment developer from the inside to the outside of the developer containing body, and the container being mounted on a developer replenishing device that conveys the replenishment developer discharged from the developer discharge outlet to a developing device, wherein
the developer containing body is filled with the single toner and a pre-mixed developer that has a carrier weight ratio lower than that of an initial developer having a mixture of a toner and a carrier and filled into the developing device in an early stage.

7. The developer container filled with developer as claimed in claim 6, wherein the developer containing body is filled with the pre-mixed developer and the single toner so that the pre-mixed developer does not exist alone in the vicinity of the developer discharge outlet inside the developer containing body.

8. The developer container filled with developer as claimed in claim 6, wherein a volume of the developer containing body is reduced as the replenishment developer is discharged therefrom to the outside via the developer discharge outlet.

9. The developer container filled with developer as claimed in claim 8, wherein at least part of the developer containing body comprises a flexible section, and wherein the flexible section deforms and thereby the volume of the developer containing body decreases as the replenishment developer is discharged therefrom to the outside via the developer discharge outlet.

10. A developer container filled with developer, the container having a developer containing body for containing a replenishment developer comprising a toner and a carrier, and a developer discharge outlet for discharging the replenishment developer from the inside to the outside of the developer containing body, and the container being mounted on a developer replenishing device that conveys the replenishment developer discharged from the developer discharge outlet to a developing device, wherein
the developer containing body is filled with a pre-mixed developer comprising an initial developer that is filled into the developing device in an early stage and with the single toner so that the pre-mixed developer does not exist alone in the vicinity of the developer discharge outlet inside the developer containing body.

11. The developer container filled with developer as claimed in claim 7, wherein the volume of the developer containing body is reduced as the replenishment developer is discharged therefrom to the outside via the developer discharge outlet.

12. The developer container filled with developer as claimed in claim 11, wherein at least part of the developer containing body comprises a flexible section, and wherein the flexible section deforms and thereby the volume of the developer containing body decreases as the replenishment developer is discharged therefrom to the outside via the developer discharge outlet.

13. A developer replenishing device, comprising:
a developer containing body for containing a replenishment developer comprising a toner and a carrier; and
developer conveying means for conveying the replenishment developer contained in the developer containing body to a developing device, wherein
the developer conveying means has a conveyance path member through which the replenishment developer passes, and a powder pump for generating negative pressure in the replenishment developer contained in the developer containing body and moving the replenishment developer to the developing device via the conveyance path member, and wherein
the developer containing body is filled with the single toner and a pre-mixed developer that has a carrier weight ratio lower than that of an initial developer having a mixture of a toner and a carrier and filled into the developing device in an early stage.

14. An image forming apparatus, comprising:
a latent image carrier;
a developing device that uses a developer contained in a developer containing body to develop a latent image formed on the latent image carrier; and
developer replenishing means for replenishing a replenishment developer into the developer containing body, wherein
developer replenishing means comprises:
a developer container for containing a replenishment developer comprising a toner and a carrier; and
developer conveying means for conveying the replenishment developer contained in the developer container to the developing device,
the developer conveying means having a conveyance path member through which the replenishment developer passes, and a powder pump for generating negative pressure in the replenishment developer contained in the developer container and moving the replenishment developer to the developing device via the conveyance path member, and
the developer container being filled with the single toner and a pre-mixed developer that has a carrier weight ratio lower than that of an initial developer having a mixture of a toner and a carrier and filled into the developing device in an early stage.
